(19) United States
(12) Patent Application Publication
(10) Pub. No.: US 2012/0189413 A1
(43) Pub. Date: Jul. 26, 2012

(54) Grain bag unloader having an improved grain flow

(76) Inventor: Gerardo Richiger, Sunchales (AR)

(21) Appl. No.: 12/930,979

(22) Filed: Jan. 21, 2011

(51) Int. Cl. B65G 65/22

(52) U.S. Cl. 414/310

(57) ABSTRACT

Disclosed are a grain chamber, and additional means inside the chamber, that handle grain in a bag unloading machine or unloader. This unloader of large sized bags has a winder or roller that gathers the used plastic as the bag is gradually emptied. As the unloader advances, sweep augers gather grain and convey it to the centrally located grain chamber. The chamber delivers the grain to a discharge auger that conveys it upwardly and outwardly to an awaiting truck, cart, or mobile container. Embodiments of the present disclosure are of a grain chamber for receiving and transferring grain, concave paddles that convey grain to the discharge auger, and a divider panel for preventing grain loss in the last stage of unloading.

### FIELD

This disclosure relates in general to grain bag unloading machines, also called grain bag unloaders, and expressly to improvements that increase the work capacity of said machines when unloading grain from bags.

### BACKGROUND

The following is a tabulation of some prior art that appears relevant at this time:

### U.S. Patent Application Publications

| Publication number | U.S. Cl. | Publication date | Applicants |
|---|---|---|---|
| US 2009/0263223 A1 | 414/584 | Oct. 22, 2009 | Twiestmeyer/Hood |
| US 2009/0311080 A1 | 414/310 | Dec. 17, 2009 | Hilsabeck |
| US 2010/0229518 A1 | 56/117 | Sep. 16, 2010 | Morici |

### Foreign Patent Documents

| Foreign Doc. number | Country | Issue date | Patentee |
|---|---|---|---|
| AR042763B1 | Argentina | Oct. 12, 2005 | Palou |

### Non-Patent Literature Documents

Dick Hagen, The Land magazine, “As Agriculture changes, so has Loftness Manufacturing” (Apr. 18, 2008 Edition).

### The Grain Bagging Technique

Grain bags, also referred to as silo bags, are large sized polyethylene tube shaped bags used to store agricultural produce. Cereal grains such as wheat, corn and rice, legumes such as peas, and oilseeds such as sunflower and soybeans are routinely kept in grain bags.

Other products in the form of pellets or other types of solid constituent parts that configure a flowable mass, such as different kinds of fertilizers, or any other organic, inorganic or synthetic product, can be put inside bags. The present disclosure, although not expressly referring to all the aforementioned materials, should be considered as covering these alternate materials in a similar way as grain, the denomination “grain” being adopted throughout the text for expediency.

The bags are made of polyethylene and vary in diameter from approximately 2 to 4 meters and in length from approximately 30 to 90 meters. Capacity can reach hundreds of metric tons. Each bag is originally a tube or sleeve open at both ends that manufacturers deliver folded in accordion-like folds or pleats. Bags are single use only and recyclable.

Grain baggers have turned the storage of grain in large bags into a quick, straightforward procedure. They are designed to perform this task as fast as combine harvesters and grain carts can deliver the grain, and bagging rates of 300 to 400 tons/hour are commonplace.

### Prior Art Roller-Type Unloaders

Although grain baggers have been in regular use for quite a few years, the design of efficient grain bag extractors or unloaders that could match the work performance of baggers has lagged behind. Contrasting with the relative simplicity of introducing grain inside bags, taking it out has proved a bigger challenge. A usual unloading chore involves transferring grain from bag to truck, typically 30 or 40 tons at a time. Front end loaders mounted on tractors and skid steer loaders are slow and cumbersome and there is too much grain lost through spillage. Pneumatic grain conveyors can be used but they are costly, require considerable maintenance, expend far more energy to move far less grain than augers, and require appreciable physical exertion from the operator handling the vacuum nozzle.

Different configurations of augers and auger equipped machines have been tried, many proving too slow and labor intensive to be practical. A typical design for unloading bags is a wheeled frame equipped with twin horizontal augers, configured in a V shape, hitched to a tractor and mechanically driven by the tractor's power take-off, or PTO (as in Mainero's model 2330). Thus to unload a bag, its end is cut open and the unloader is driven rearwardly into it, its wheels stepping on the floor of the bag and the horizontal augers spread to fit the bag. This design has shortcomings such as:

a) the tractor must frequently engage in backward and forward maneuvering to realign the unloader's augers inside the bag and collect all the grain. This entails loss of time and considerable wear of tractor clutch components;
b) besides the tractor operator, one or two additional workers are needed to monitor the procedure and to hold the entrance flaps open for the unloader to maneuver inside the bag;
c) the collecting augers scrape the bottom of the bag but are unable to collect the totality of the grain;
d) the used plastic sheet is not gathered by the unloader for disposal later at a convenient location.

One particular variant solved many of these problems (Palou Patent AR042763B1 awarded Oct. 12, 2005, Argentina). The Palou-type unloader, or roller-type unloader, as shown in prior art is powered by a tractor's power take-off and hydraulic system, and operation is automatic and ongoing once grain discharge rate is adjusted. A single operator, who is also in charge of the tractor, is needed to supervise the operation. The tractor's PTO supplies mechanical power to the augers, and its hydraulic pump powers the rotatable roller. The basic working principle of the roller-type unloader is the variable speed, hydraulically driven rotatable roller or winder that acts as a winch and reels in the bag's plastic sheet as the augers collect grain and empty the bag. Simultaneously, the winch pulls along as a tandem the unloader and the attached tractor that provides power. The grain inside the bag acts as an anchor for the advancing tandem. The plastic sheet itself is resistant to traction and will not break under the strain.

The grain unloading rate is determined by roller speed. Roller speed can be varied in small increments and the maximum discharge rate that can be achieved is dependent on the type of grain and how well it flows (better flow characteristics equals more speed), the grain's degree of cleanliness (cleaner grain equals more speed) and its moisture content (drier grain equals more speed). The tractor can be pulled easily because its gearbox is disengaged and its brakes are off while it provides mechanical and hydraulic movement to the unloader through its power-take off and its hydraulic system.

A knife or cutter blade assembly at the top rear of the unloader slashes through the top section of bag as the unloader/tractor tandem is pulled, permitting the uptake of plastic by the roller. As the machine advances, mechanically driven horizontal sweep augers, also called collecting or cross augers, work by gathering grain across the width of the bag. The augers work at a constant speed throughout the unloading sequence, moved by the PTO turning in its upper rpm range, independently of whether roller speed diminishes or increases.

The sweep augers transport the grain to a centrally located reception and transfer point or grain chamber from which it is discharged through an upwardly oriented discharge auger. Since tractor and unloader move at the pace dictated by roller velocity, the movable container, i.e., grain cart or truck receiving the grain must move every so often so keep alongside. Besides receiving grain from the sweep augers, the grain chamber has a frontal opening or window that permits additional grain entry as the unloader advances. The grain chamber lies more or less submerged in grain depending on grain characteristics. The grain that is conveyed into the grain chamber is then picked up by the discharge auger that sends it upwardly and outwardly to a waiting truck or grain wagon. The unloader works at a constant, steady pace, with no time lost in maneuvering back and forth or repositioning augers inside the bag. As the plastic is rolled in, grain left on the floor of the bag that was not picked up by the sweep augers in the first pass is normally dumped back into the bag as the floor is raised by the roller, thus ensuring it will eventually be picked up. With this system there is no grain loss as can occur with an open ended bag because the grain is always enfolded by the bag and there is no opening for spillage to occur. Once unloading labors are finished, the plastic sheet is cut off from the roller and the bag is resealed to protect its remaining contents. Then the roller is disengaged so that it turns freely and the plastic to be discarded is unrolled on the ground by driving forward.

### General Characteristics of Prior Art Roller-Type Unloaders

Several companies (Akron, Palou, Richiger, Loftness) went ahead with manufacturing plans based on the new roller-type design.

The unloading rate being obtained today—in real world conditions—with state of the art roller-type unloaders is in the order of one hundred and fifty to two hundred and fifty tons/hour with dry corn. These figures are considered excellent and are the highest obtained to date with grain bag unloading machines of any kind. Nevertheless issues remain that have not been recognized by the industry.
a) The central reception and transfer point or grain chamber as conceived in prior art is a roughly cube shaped simple enclosure where grain flows in and out transported by augers. Prior art roller-type unloaders have been equipped with flat pusher vanes or blades sandwiched between screw augers that converge inside the grain chamber. Grain inundates the chamber so that sweep augers and the lower section of the discharge auger are immersed in it. Sweep augers and discharge auger are close enough to each other that the pusher vanes have semi-circular sections cut out from their leading edges to stay well clear of the discharge auger's spiral flight area. This reduces the vanes' total surface and taxes their capacity to push grain forward. Pusher vanes have been a complement but not an essential constituent of prior art design. Grain flow through the central chamber has been considered a more or less direct transfer of grain between augers with little loss of efficiency in the process.
   The direct conveying of grain from one auger to another, or the use of a transfer point such as a compartmentalized sector flooded with grain from which an auger draws grain, which is the mechanism basically used by prior art bag unloaders, is the standard in the industry. These direct means of grain transfer are used in grain carts, grain drill augers, gravity wagons, swing away augers, and in general in machinery that transport and handle grain. Grain output figures obtained in grain bag unloaders have satisfied manufacturers and users.
b) The high point in the direct transfer of grain from sweep augers to discharge auger came about when some manufacturers (Akron, Palou) completely eliminated pusher vanes in their models. In this version of the grain chamber, the sweep augers intersect with the discharge augers on the same plane. Overall efficiency did not differ much from that of previous models fitted with flat pusher vanes, and even better efficiency as measured in ton per hour output has been claimed by manufacturers that opted for this approach.
c) One particular aspect of the broader challenge of optimizing and increasing grain flow and throughput is that grain sometimes bypasses the sweep augers and too much accumulates in the end section of bag behind the augers, where the floor of the bag is lifted by the roller. Sometimes it is necessary to radically slow down the operation—in other words to slow down roller revolutions per minute that determine advance speed and thus grain extraction speed—in order to let this bulging mass of grain break down and allow it to be gradually taken up by the collecting augers. Otherwise the weight of the accumulated grain as the roller tugs at the plastic can stretch and tear the bag, spilling its contents. Or the grain can stretch the bag to the point that it makes contact and scrapes against the unloader's wheels, additionally endangering its integrity.
d) Nevertheless, slowing down does not always solve the problem because once grain has accumulated at the end section of the bag it tends to stay there, out of direct reach of the sweep augers. If the problem persists, it may be necessary to interrupt the operation, disengage the roller and drive the tractor forward to unwind plastic from the roller. This relieves pressure inside the bag as the accumulated mass of grain caves in and crumbles when the collecting augers are pulled out. The unloading operation is resumed at a slower pace. All this involves loss of time.
e) Manufacturers have tried ways of solving the problem detailed in point (c). Loftness offers an optional hydraulic auger assembly in its GBU model that is mounted on the rear of the grain chamber, opposite the main collecting augers. Installed nearer the end section of bag where accumulation occurs, the auxiliary auger assembly aims to direct grain back to the grain chamber sector where it can be collected. However, the option adds complexity and cost. Akron has mounted a hydraulic pusher on the frame of their EXG 300 model, a large rectangular shield that pushes against the bag's end section at operator's demand. This action helps prevent undue accumulation of grain by applying sheer pressure on the bulging section of bag. The hydraulic pusher adds more movable parts and more expense, and does not contribute to better efficiency or a faster rate of grain extraction at any stage of the unloading process. Manufacturers have considered grain accumulation as a tangential consequence of grain bag unloading, a drawback intrinsic to the system that can occur in certain circumstances.
f) The solutions tried by different manufacturers to solve excessive grain accumulation have addressed the visible consequences of the problem, but have not focused on the basic causes. The crux of the matter lies in the grain flow dynamics determined by the grain chamber. Improved grain flow not only prevents excessive grain accumulation in the problematic end section of the bag, but considerably speeds up the rate of extraction as a whole while using less power to do so.
g) Rate of extraction is not as efficient as it could be in prior art machines. When grain reaches the grain chamber of prior art machines via sweep augers, a certain amount of it may still not reach the discharge auger. As explained in point (h) below, grain may be ejected through the grain chamber's front opening, which purpose is to collect additional grain as the unloader advances, or grain flow can be otherwise adversely affected as explained in points (i), (j) and (k) below. These phenomena are not normally visible because they occur for the most beneath the surface of the grain. The grain that is expelled from the chamber, or that cannot be channeled rearward to the discharge auger, can migrate to the bag's end and thus contribute decidedly to the accumulation problems described. I have determined that there are several factors that interact within the grain chamber or in its immediate vicinity. These can affect throughput before grain reaches the discharge auger. The discharge auger receives less grain, and conveys out of the bag an amount that is below its potential conveying capability.
h) The first factor is ejection and generalized turbulence due to increased grain pressure within the chamber. This occurs when the chamber cannot process all of the grain brought in by the sweep augers, causing a bottleneck. The sweep augers will attempt to force-feed grain into the chamber. If its lateral entrances are blocked because there is no room inside for more, part of the grain will backtrack away from the chamber. Nevertheless, a quantity of the grain will be rammed in forcefully by the sweep augers, at the cost of more horsepower expended in the process. Part of that grain will end up in the discharge auger, but part will be forced out through the chamber's front opening. Simultaneously, and in opposing direction to this grain forcibly discharged, grain enters through the chamber's front opening as the unloader advances.
i) The second factor is centrifugal force. In prior art unloaders, the end sections of the sweep augers—end section defined as the auger section that works inside the grain chamber—overlap with the chamber's front opening that takes up most of the chamber's frontal section, so they are exposed. As they turn they generate centrifugal force that forces some grain outward. This introduces turbulence in the chamber. The sweep augers generate centrifugal force all along their length, but within the chamber it imposes on efficiency more noticeably.
j) The third factor is the rotational movement of the vanes. As the flat vanes turn, they stir the grain and produce a churning action that further introduces turbulence inside the grain chamber.
k) The fourth factor that affects the smooth passage of grain is disruption of the stream of grain brought in by the sweep augers. In prior art models the sweep augers are uncovered or exposed within the grain chamber. Their grain makes contact with the grain coming in through the chamber's front opening as the unloader advances. This contact tends to displace and disrupt the grain carried by the sweep augers, introducing turbulence.
l) The factors mentioned in the previous points are complementary and interact in differing degrees. In summary, any factor that causes tossing and churning of grain in the chamber or at its front opening has a negative effect on throughput. The smoother and steadier the flow of inward bound grain, the better the efficiency.
m) A further drawback of the prior art grain chamber is its cubic shape and the resistance force it generates advancing through the mass of grain. Since the force to pull the tractor and unloader tandem must be borne by the plastic sheet as the roller collects it, added drag means more strain on the plastic. This can be critical in hot weather, as high temperatures contribute to stretching that can result in bag rupture.
n) All roller type machines mentioned, when reaching the end section of a bag after discharging its contents, must stop their advance. Nevertheless a portion of grain does remain in this last section that cannot be reached by the sweep augers and so must be unloaded manually. One embodiment of this disclosure involves modifications to the grain chamber and means within to speed up this manual stage of the unloading process.

### Advantages

Thus several advantages of one or more aspects are accrued in a machine, as defined in embodiments of this disclosure, which unloads significantly greater quantities of grain per hour than similar units. The added capacity is attained without augmenting variables such as auger dimensions. The embodiments presented in this disclosure permit sweep auger revolutions per minute to be substantially decreased with no loss in efficiency. Improved grain flow allows the use of smaller sized tractors, resulting in less expenditure of energy for a given amount of work. Improved grain flow reduces or prevents the problematic accumulation of material at the end section of bag, resulting in better standards of bag integrity and dependability. Other advantages of one or more aspects will be apparent from a consideration of the drawings and corresponding description of component parts and operation.

### SUMMARY

In accordance with one embodiment, the modifications to the grain chamber and means contained within the chamber provide improved work efficiency in the discharge of grain, as measured in tons unloaded per hour of work.

### SHORT DESCRIPTION OF DRAWINGS

FIG. 1A shows the first part of a view of a prior art unloader seen from the left side.

FIG. 1B shows the second part of a view of a prior art unloader seen from the left side.

FIG. 1C is a close-up view of the hydraulic and mechanical drive depicted in FIG. 1B.

FIG. 2A shows the first part of a view of a prior art unloader seen from the rear side.

FIG. 2B shows the second part of a view of a prior art unloader seen from the rear side.

FIG. 3 shows a sectional view diagram, as seen from the side, of a bag with normal grain accumulation.

FIG. 4 shows a sectional view diagram, as seen from the side, of a bag with excessive grain accumulation

FIG. 5 shows a perspective view of an unloader emptying a bag.

FIG. 6 shows a partial schematic of an unloader and a grain bag seen from above.

FIG. 7 shows a perspective view of a prior art grain chamber.

FIG. 8 shows a perspective view of prior art flat pusher vanes.

FIG. 9 shows a perspective view of a prior art unloader's grain chamber with augers and pusher vanes.

FIG. 10 shows a head-on frontal view of a prior art unloader's grain chamber with augers, pusher vanes and discharge tube.

FIG. 11 shows a head-on front view schematic of a second type of prior art unloader's grain chamber having no pusher vanes.

FIG. 12 is a diagram showing the relative position, as seen in a side view, of a prior art unloader's sweep augers relative to its discharge auger.

FIG. 13 is a diagram showing the relative position, as seen in a side view, of a second type of prior art unloader's sweep augers relative to its discharge auger.

FIG. 14 is a diagram showing the relative position, as seen in a side view, of this disclosure unloader's sweep augers relative to its discharge auger.

FIG. 15 shows a perspective view of the cylindrical grain chamber of the first embodiment of this disclosure.

FIG. 16 shows a perspective view of the scooped pusher vanes of the first embodiment of this disclosure.

FIG. 17 shows a head-on view, as seen from the side, of scooped pusher vanes mounted on a central shaft of the first embodiment of this disclosure.

FIGS. 18A, 18B, 18C and 18D show a sequence of perspective views of a gyrating set of scooped pusher vanes of the first embodiment of this disclosure.

FIG. 19 shows a perspective view of the cylindrical grain chamber with augers, scooped pusher vanes and discharge tube of the first embodiment of this disclosure.

FIG. 20 shows a head-on view, as seen from the front, of the cylindrical grain chamber with augers, scooped pusher vanes and discharge tube at the rear, of the first embodiment of this disclosure.

FIG. 21 shows a perspective view of the rear section of a grain bag unloader fitted with components for the manual loading of grain, of the second embodiment of this disclosure.

FIG. 22 shows a perspective of a partition and other parts for preventing the loss of grain, of the second embodiment of this disclosure.

FIG. 23A shows a sectional diagram, as seen from the side, of the grain chamber with the entry and passage points of grain, of the second embodiment of this disclosure.

FIG. 23B shows a sectional diagram, as seen from the side, of the grain chamber with discharge augers, sweep augers, pusher vanes, an auxiliary hopper, and a curved partition, of the second embodiment of this disclosure.

FIG. 23C shows a sectional diagram, as seen from the side, of the grain chamber with discharge augers, sweep augers, pusher vanes, auxiliary hopper, curved partition and an end bracket, of the second embodiment of this disclosure.

FIG. 24 shows a head-on view, as seen from the front, of the scooped pusher vanes with central shaft and spiral flights, of the third embodiment of this disclosure.

FIG. 25 shows a head-on view, as seen from the front, of the cylindrical grain chamber with augers and scooped pusher vanes, of the third embodiment of this disclosure.

FIG. 26 shows a head-on view, as seen from the front, of the grain chamber, sweep augers, and scooped vanes, of the fourth embodiment of this disclosure.

FIG. 27 shows a partial sectional perspective view of the grain chamber, discharge tube and other parts that correspond to the fourth embodiment of this disclosure.

FIG. 28 shows a partial sectional perspective view of the grain chamber, as seen from the front, of a grain chamber and other parts that correspond to the fourth embodiment of this disclosure.

FIGS. 29 to 36 show different types of scooped pusher vanes or paddles.

### DRAWINGS

### Reference Numerals

1) Roller type unloader
2) Tractor
3) Unloader frame
4) Wheel
5) Hitch
6) PTO drive shaft
7) Tractor PTO
8) Front upright frame member
9) First roller chain
10) Long drive shaft
11) Horizontal frame member
12) Second roller chain
13) Rear upright frame member
14) Dual output shaft gear case
15) Downwardly extending output shaft
16) Housing
17) Third roller chain
18) Housing
19) Lower discharge auger (sometimes referred to as discharge auger)
20) Lower discharge tube (sometimes referred to as discharge tube)
21) Upper discharge auger
22) Upper discharge tube
23) Discharge spout
24) Discharge tube hinge
25) Hydraulic cylinder
26) Stand
27) Cutter blade assembly
28) Bag pickup roller
29) Hydraulic command center
30) Transverse support frame member
31) Support bracket
32) Roller end stub
33) Flange disc
34) Hydraulic motor
35) Reduction gear case
36) Gear case output shaft
37) Housing
38) Fourth roller chain
39) Laterally extending output shaft
40) Housing
41) Gear case
42) Disconnect handle
43) Fifth roller chain
44) Housing
45) Sweep auger central shaft
46) Right sweep auger
47) Left sweep auger
48) Left-hand spiral flight
49) Right-hand spiral flight
50) Grain chamber, 1^{st} type prior art
51) Front opening, 1^{st} type prior art
52) Flat pusher vane, 1^{st} type prior art
53) Grain chamber side opening, 1^{st} type prior art
54) Central bracket
55) Left side bearing block
56) Right side bearing block
57) Side shield
58) Bag holding stud
59) Grain bag
59a) Grain bag upper section
59b) Grain bag lower section
60) Grain mass within bag
61) Grain chamber rear opening, 1^{st} type prior art
62) Right sweep auger, 2^{nd} type prior art
63) Right central shaft, 2^{nd} type prior art
64) Left-hand spiral flight, 2^{nd} type prior art
65) Left sweep auger, 2^{nd} type prior art
66) Left central shaft, 2^{nd} type prior art
67) Right-hand spiral flight, 2^{nd} type prior art
68) Grain chamber, 2^{nd} type prior art
69) Grain discharge auger, 2^{nd} type prior art
70) Grain discharge tube, 2^{nd} type prior art
71) Front opening, 2^{nd} type prior art
100) Grain chamber/reception and transfer point, all except 4^{th} embodiment
100a) Grain chamber/reception and transfer point, 4^{th} embodiment
101) Cylindrical front section, all except 4^{th} embodiment
101a) Cylindrical front section, 4^{th} embodiment
102) Rear prolongation, all embodiments
103) Grain passageway, all embodiments
104) Front opening, all except 4^{th} embodiment
104a) Front opening, 4^{th} embodiment
105) Tray extension, all except 4^{th} embodiment
105a) Tray extension, 4^{th} embodiment
106) Grain inlet, all embodiments
107r) Right side scooped pusher vane, 1^{st} and 4^{th} embodiments
107l) Left side scooped pusher vane, 1^{st} and 4^{th} embodiments
108r) Right side scooped pusher vane, 3^{rd} embodiment
108l) Left side scooped pusher vane, 3^{rd} embodiment
109) Auxiliary hopper, 2^{nd} embodiment
110) Curved partition, 2^{nd} embodiment
111) Removable end bracket, 2^{nd} embodiment
112) Fixed end bracket, 2^{nd} embodiment
113) Pin, 2^{nd} embodiment
114) Clip fastener, 2^{nd} embodiment
115) Handle, 2^{nd} embodiment
116) Side opening, left and right, all embodiments
117r) Right side scooped pusher vane, 4^{th} embodiment
117l) Left side scooped pusher vane, 4^{th} embodiment
118) Inner partition, cylindrical front section, 4^{th} embodiment
200) Scooped pusher vane, single model
201) Scooped pusher vane, single model
202) Scooped pusher vane, single model
203) Scooped pusher vane, single model
204r) Scooped pusher vane, right side
204l) Scooped pusher vane, left side
205r) Scooped pusher vane, right side
205l) Scooped pusher vane, left side
206) Scooped pusher vane, single model
207) Scooped pusher vane, single model

### DETAILED DESCRIPTION OF DRAWINGS

### I) Description of a Grain Bag Unloader, Bag Characteristics, and Prior Art Constituents

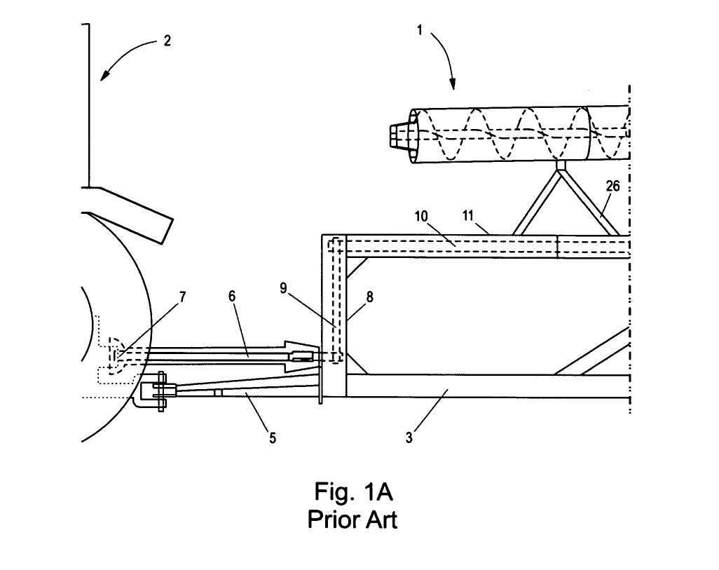

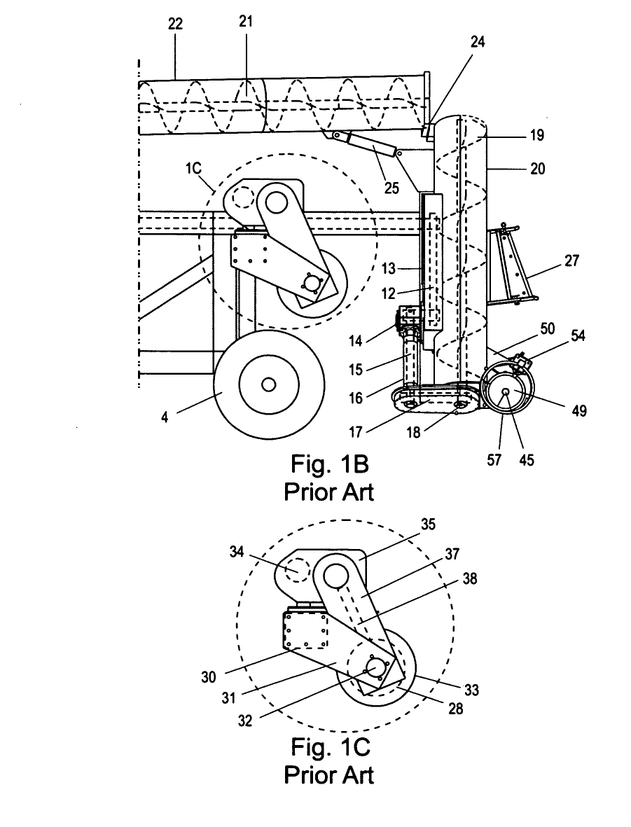

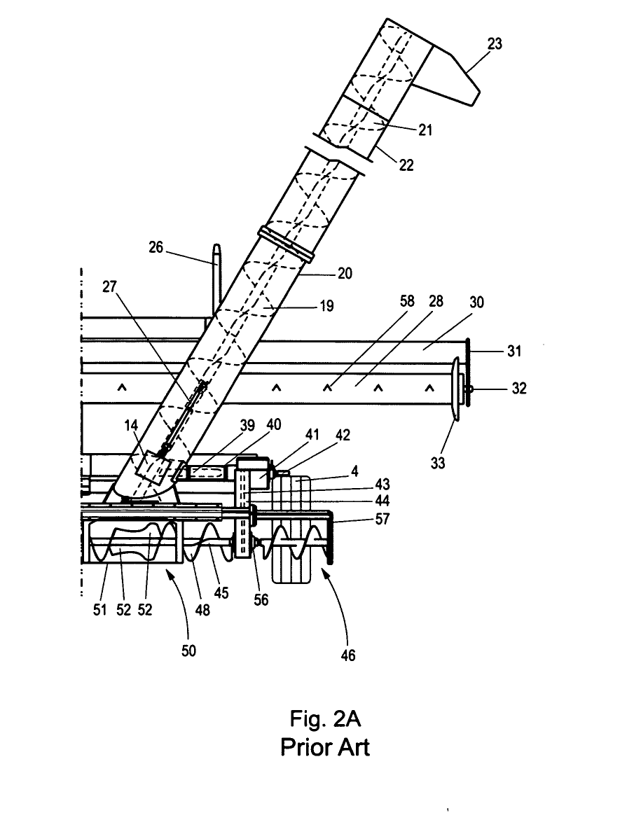

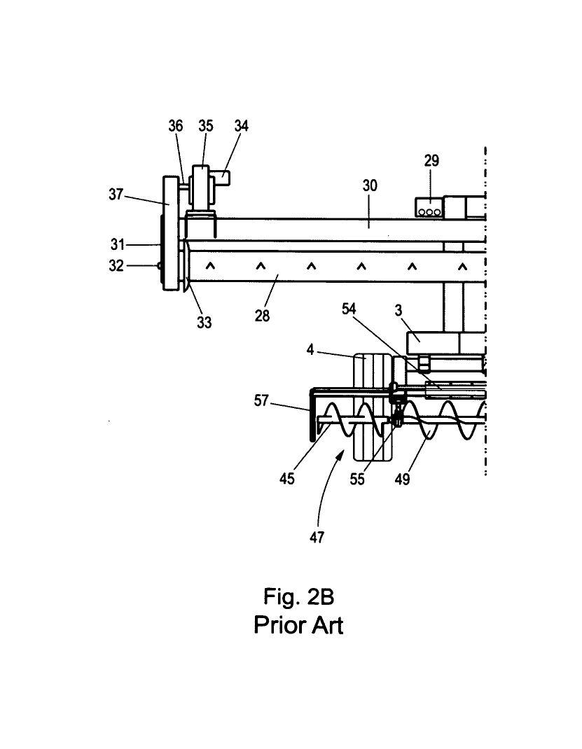

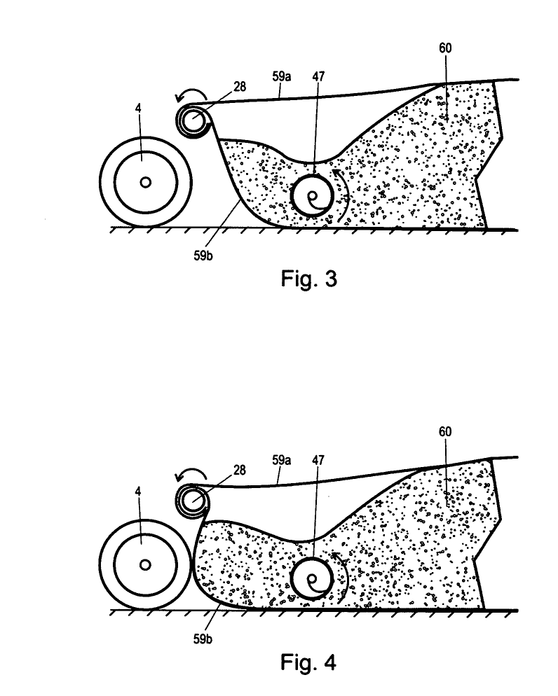

FIGS. 1A, 1B, 1C, 2A and 2B show perspective views looking to the left side and the rear side of an unloader and depict the general workings of the roller-type unloader. It is described herein because it shows the general working mechanisms of all roller-type machines, including the machines of this disclosure, so the examiner may become familiar with their habitual layout. In FIGS. 1A, 1B, 1C, 2A and 2B all the parts described are applicable to the present disclosure as well, except for parts depicted by numerals 50, 51 and 52 in FIG. 1B that are exclusive of prior art machines. Components that replace parts 50, 51 and 52 in FIG. 2B comprise embodiments of the present disclosure. To distinguish prior art from the present disclosure and its embodiments, components of the present disclosure and embodiments will be denominated with numeration starting from number 100 onward. These will be apparent from a consideration of the drawings and account provided in the latter part of the description.

Although the present disclosure is based on a grain bag unloader powered by a conventional tractor because this is the method most commonly used, it should be construed to encompass grain bag unloaders powered by other means, including not only external means as provided by tractors or other types of vehicles, but means mounted on a bag unloader itself to convert it, with adaptations such as the inclusion of a forward wheel or set of wheels for machine front end support, into a self-powered unit.

FIGS. 1A and 1B: In FIG. 1A, grain unloader 1 is attached to tractor 2. Grain bag unloader 1 includes a wheeled frame 3 running on wheels 4 (FIG. 1B). Besides allowing movement intrinsic to the system, wheels 4 are mounted to the rear of frame 3 to enable raising and lowering for differentiated transport and working height configurations. Frame 3 includes a forwardly extending tongue or hitch 5 which is adapted to be secured to the tractor 2 in conventional fashion. PTO drive shaft 6 is adapted to be connected to the power take-off or PTO 7 in conventional fashion. The rearward end of PTO drive shaft 6 is connected to a 1^{st} gear (not shown) which is rotationally mounted within a casing or housing formed by upright frame member 8, which is a structural constituent of frame means 3. A first roller chain 9 depicted by dotted lines extends around the 1^{st} gear, then extends upwardly in the housing formed by frame member 8 and extends around a 2^{nd} gear (not shown) mounted rotationally on the forward end of long drive shaft 10 which is depicted by dotted lines and extends rearwardly along hollow beam or horizontal frame member 11, which is a structural constituent of frame 3.

In FIG. 1B, the rearward end of drive shaft 10 has a 3^{rd} gear (not shown) mounted rotationally thereon. A second roller chain 12 depicted by dotted lines extends around the 3^{rd} gear and extends downwardly in rear upright frame member 13 that doubles as housing for the roller chain, where it extends around a 4^{th} gear (not shown) that is rotationally mounted on the input shaft (not shown) of dual output shaft gear case 14. A 5^{th} gear (not shown) inside gear-case 14 is rotationally mounted on the upper end of downwardly extending output shaft 15 which is depicted by dotted lines and is the first of two output shafts of gear-case 14. Output shaft 15 extends within a housing or casing 16. A 6^{th} gear (not shown) is rotationally mounted on the lower end of shaft 15 and has a third roller chain 17, depicted by dotted lines, extending around it and extending thereon rearwardly along casing or housing 18. Roller chain 17 extends around a 7^{th} gear (not shown) which is rotationally mounted on the lower end of a shaft stub (not shown) connected upwardly and inwardly to the central shaft of the lower discharge auger 19. Lower discharge auger 19 is enclosed by a lower discharge tube 20 and connects to an upper discharge auger 21, which is enclosed in an upper discharge tube 22, by means of connecting stubs (not shown) fitted to the central shafts of the augers.

Upper discharge tube 22 ends in a discharge spout 23, missing in FIG. 1A but depicted in FIG. 2A. Connection of upper and lower discharge augers is accomplished when upper and lower tubes joined by hinge 24 come together, as shown in FIG. 2A, as hydraulic cylinder 25 (FIG. 1B) is set to its extended position. When hydraulic cylinder 25 is closed, the upper discharge tube 22 comes to rest on stand 26 (as shown in FIG. 1B). Cutter blade assembly 27 slashes open the upper section of bag as the unloader advances. Numerals 45, 49, 50, 54 and 57 depict the sweep auger central shaft, the right-hand spiral shaft, the grain chamber, the central bracket and the side shield respectively from a sidewise viewpoint in FIG. 1B, but are seen from a frontal viewpoint and described in the account corresponding to FIGS. 2A and 2B.

FIG. 1C is an enlarged section of FIG. 1B and shows a side view of the hydraulic and mechanical transmission components that drive the rotatable bag winder or roller 28 of which there is a front view in FIGS. 2A and 2B. Back to FIG. 1C, a detailed account is beyond the scope of this description so hydraulic hoses, fittings and connections are not detailed herewith, including the connection to the tractor's hydraulic system or other means that is standard state of the art. A hydraulic flow control valve allows operator control of the revolving speed of bag roller 28, and a hydraulic lever allows reversal of the bag roller's turning direction. These controls are located in a hydraulic command center 29 positioned on transversely extending support frame member 30 (see also FIG. 2B). For machine transport, frame member 30 turns around 90° for longitudinal alignment with frame 3, to which it is pivotally attached. Two support brackets 31, attached to frame member 30, hold up bag roller 28 at each extremity through roller end stubs 32.

Twin flange discs 33 are affixed to each end of roller 28 to keep plastic sheet aligned as the roller collects it (see also FIGS. 2A and 2B). A hydraulic motor 34 mounted atop frame member 30 (see also FIG. 2B) is rotationally connected to a reduction gear case 35. Gear box output shaft 36 (not shown in FIG. 1C, but shown in FIG. 2B) is connected to a 8^{th} gear (not shown) rotationally mounted within a casing or housing 37 (see also FIG. 2B), around which extends a fourth roller chain 38 depicted by dotted lines. Roller chain 38 extends downwardly in housing 37 to extend around a 9^{th} gear (not shown). The 9^{th} gear is rotationally mounted to roller end stub 32 for providing turning motion to bag roller 28. Thus several of the elements described in this account of FIG. 1C comprise a power and transmission means for powering bag pickup roller 28. The method whereby this is achieved can vary substantially in different versions of roller-type bag unloading machines. For example, the employment of open faced gears and chains instead of a closed gear box, or of a motor type other than hydraulic is feasible, but would still comprise a means with a purpose similar to means described herein for driving the bag pickup roller.

FIGS. 2A and 2B: In FIG. 2A, continuing with the main driveline component description, a 10^{th} gear (not shown) in gear case 14 is rotationally mounted to the leading end of a laterally extending output shaft 39, which is depicted by dotted lines and is the second of the two output shafts of gear case 14, the first of which was depicted under numeral 15 in FIG. 1B. Shaft 39 extends within a casing or housing 40 and its outward end is rotationally mounted to a 11^{th} gear (not shown) of the coupling gear type. A 12^{th} gear (not shown) of the coupling gear type is rotationally mounted to the input shaft (not shown) of gear case 41. For operator safety reasons, the 11^{th} and 12^{th} coupling gears permit connection and disconnection of the main drive to the sweep augers through a handle or lever 42. A 13^{th} gear (not shown) is rotationally mounted to the output shaft (not shown) of gear case 41. A fifth roller chain 43, depicted by a double dotted line, extends around the 13^{th} gear and extends thereon downwardly along casing or housing 44, whereupon it extends around a 14^{th} gear (not shown) that is rotationally mounted to the sweep augers' central shaft 45. For reason of convenience, the sweep auger is divided into a right sweep auger 46 and a left sweep auger 47, but both are actually a unified component driven by shared central shaft 45.

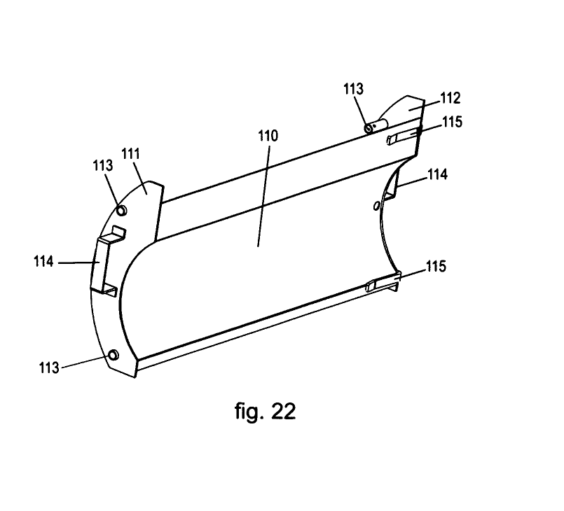

The right and left sides of the unloader are referenced by standing behind the machine and looking ahead in the direction of the tractor's forward advance, that is, when the observer positioned on the terrain has the same view of the machine as is depicted in FIGS. 2A and 2B. The right sweep auger 46 is outfitted with left-hand spiral flight 48, and the left sweep auger 47 is outfitted with right-hand spiral flight 49, thus establishing grain circulation inside the bag from outward sector to inward sector, that is from the sides of the bag to its center. The grain chamber 50 to which right and left sweeper augers converge has a front opening 51 through which can be seen the two pusher vanes 52 mounted to central shaft 45 and also attached individually, one of them to left-hand spiral flight 48 that belongs to right sweep auger 46, and the other to right-hand spiral flight 49 that belongs to left sweep auger 47. Right sweep auger 46 and left sweep auger 47 enter the grain chamber through two side openings on the right and the left face of the chamber respectively. They are assigned numeral 53 and are denominated as side openings. Although not directly visible on FIG. 2a or 2B, they will be shown in other Figs. such as FIG. 15.

The main driveline comprised by the tractor's PTO and the rest of the drive components described here constitute a power and transmission means for powering the grain sweep augers and the discharge auger that may vary slightly or substantially in different brands and models of roller-type grain unloaders.

In FIGS. 2A and 2B, other elements are a central bracket 54 that holds a bearing block 55 mounted on central shaft 45 to support the left side sweep auger section. A bearing block 56 is fitted to the end section of casing 44 and is mounted on central shaft 45 to support the right side sweep auger section. Bracket 54 also supports side shields 57 to prevent contact between the plastic bag sides and the outer ends of the sweep augers. Bag fastening studs 58 for attaching the plastic sheet are welded every 50 centimeters or so to the bag pickup roller. The sweep augers are surrounded by an open steel mesh or enclosure for reason of bystander safety, but these are omitted as they have no direct operational function.

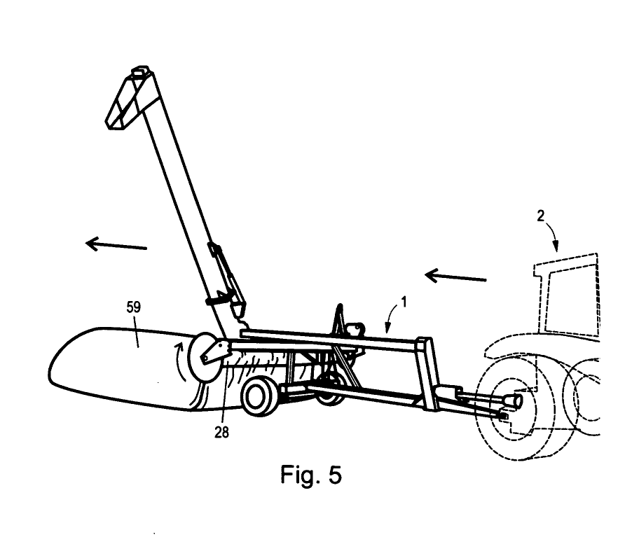

FIG. 3: This is a sectional view diagram, as seen from the left side of the unloader, of normal grain accumulation in a bag's front end. Left sweep auger 47 is immersed in grain mass 60 and bag roller 28 is pulling in a bag's lower section 59b, along with a bag's upper section 59a. The grain discharge auger and discharge tube are not shown. The bag's front end has a slight bulge, which is normal, and has good clearance to wheel 4.

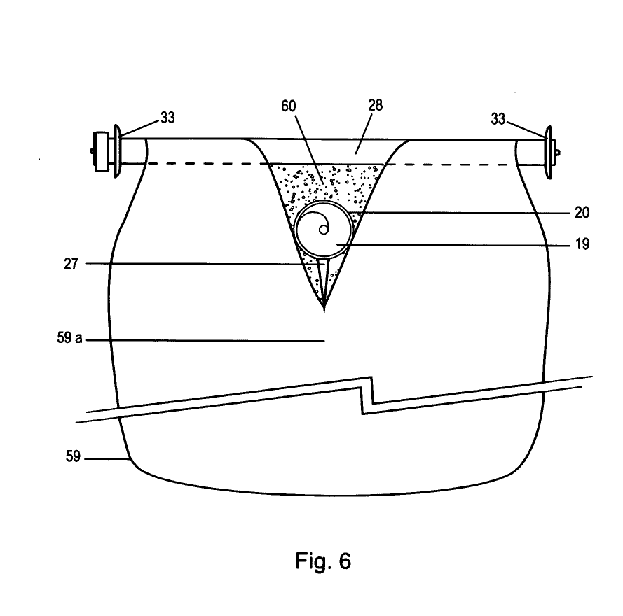

FIG. 4: This is a sectional view diagram, as seen from the left side of the unloader, of excessive grain accumulation in a bag's front end. Left sweep auger 47 is immersed in grain mass 60 and bag roller 28 is pulling in the bag's lower section 59b, along with the bag's upper section 59a. The grain discharge auger and discharge tube are not shown. The bag's front end bulge is dangerously enlarged and scrapes against wheel 4.

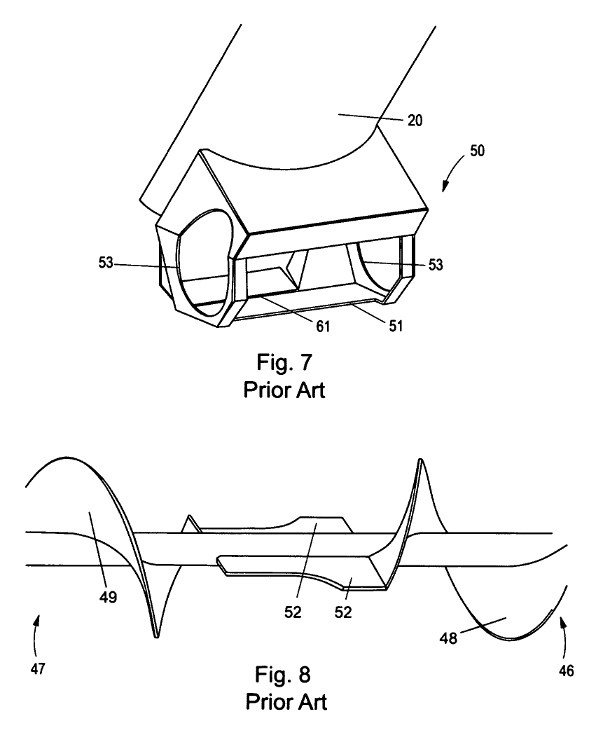

FIG. 5: This is a perspective of unloader 1 in the process of discharging grain from a grain bag 59 while attached to tractor 2. The plastic sheet is collected by roller 28. Motion arrows shows the rearward direction of advance of the tractor and unloader tandem. The tandem is pulled along by the plastic that is rolled in as emptying of the bag proceeds, while the weight of the grain in the bag acts as an anchor.

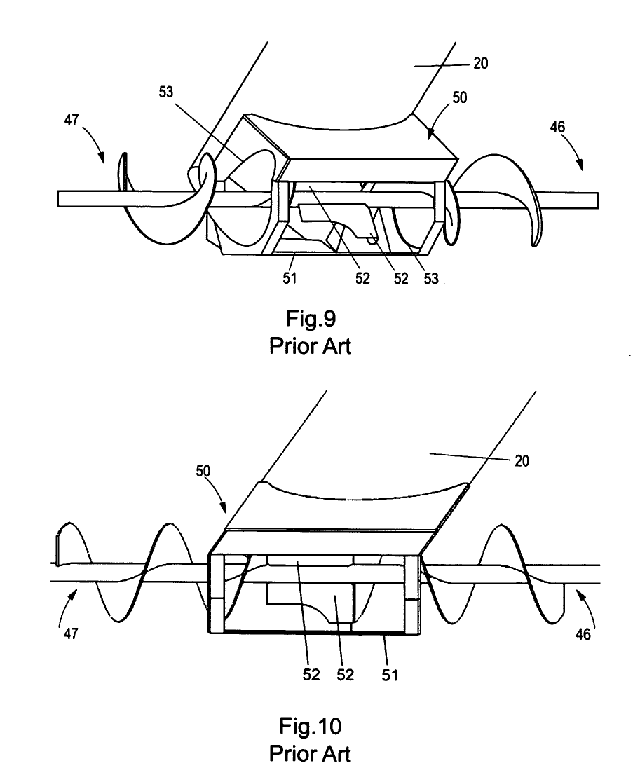

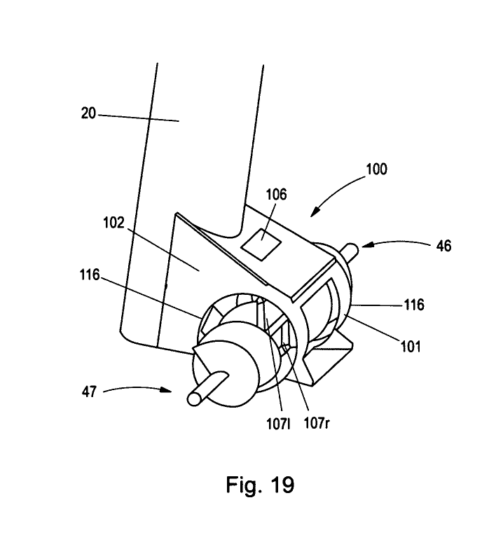

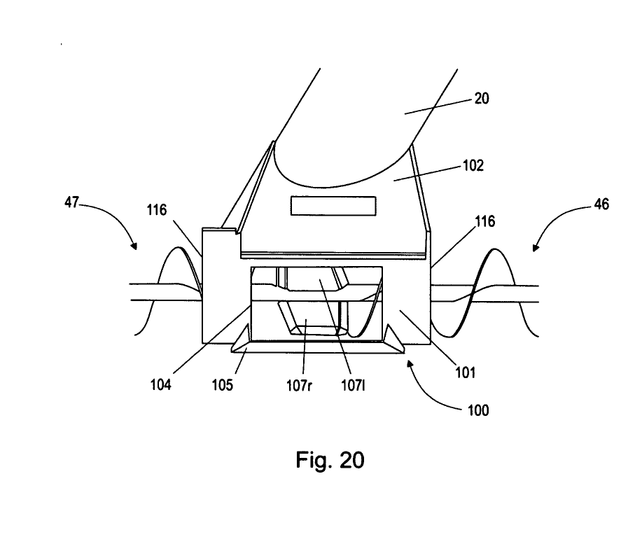

FIG. 6: This is a partial schematic of the unloader showing some details, as seen from above, in the unloading of grain bag 59. Bag 59 is attached to roller 28 flanked by flanges 33. The upper section of bag 59, denominated with numeral 59a is being slashed in two halves as it is taken in by roller 28. The slit is done by cutter blade 27 located at the rear of lower discharge tube 20 that encloses lower discharge auger 19. The mass of grain 60 is visible through the open slit. The continuous slit allows the roller to reel in the bag's upper section 59a while the lower section or bag floor, denominated with numeral 59b not shown here (see FIGS. 12 and 13) is simultaneously raised and collected by the roller. Throughout this account reference will often be made to a discharge auger and a discharge tube when actually referring to the lower discharge auger and to the lower discharge tube. Operationally, the terms are interchangeable.

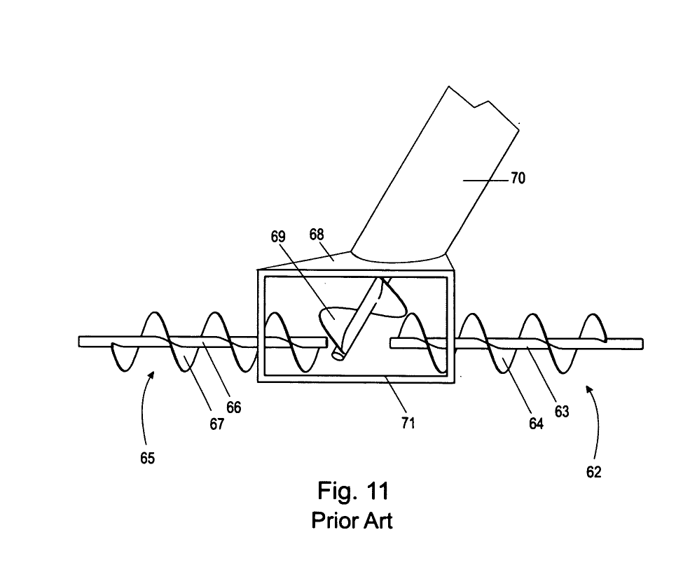

FIG. 7: This perspective view shows grain chamber 50 as a fundamental component of a first type of prior art unloader. It has a front opening 51 and lateral or side openings 53 that open to left and right. To these is added a rear opening 61 through which grain is funneled backward to adjoining lower discharge tube 20.

To avoid possible confusion when reading through the present disclosure, a clarification is in order here. The grain chamber installed to the rear of the unloader has its visible “back” or “rear” face in a plane parallel to the rear face of the unloader, so both surfaces are coincident to a viewer situated behind the latter. However, for this and for all grain chamber embodiments described in the present disclosure, the visible face is considered by convention to belong to the chamber's front side and not to its back side. Therefore, while the unloader is said to be advancing rearwardly or in a rearward direction inside the bag, the pusher vanes inside the chamber are considered to be thrusting grain backward or rearward, and not forward, onto the discharge auger. This means that the rearward movements mentioned are running in opposite directions to one another, but it is not a contradiction in terms. What defines rearward or forward movement depends on the criterion adopted over which are the front and back ends of unloader and grain chamber respectively.

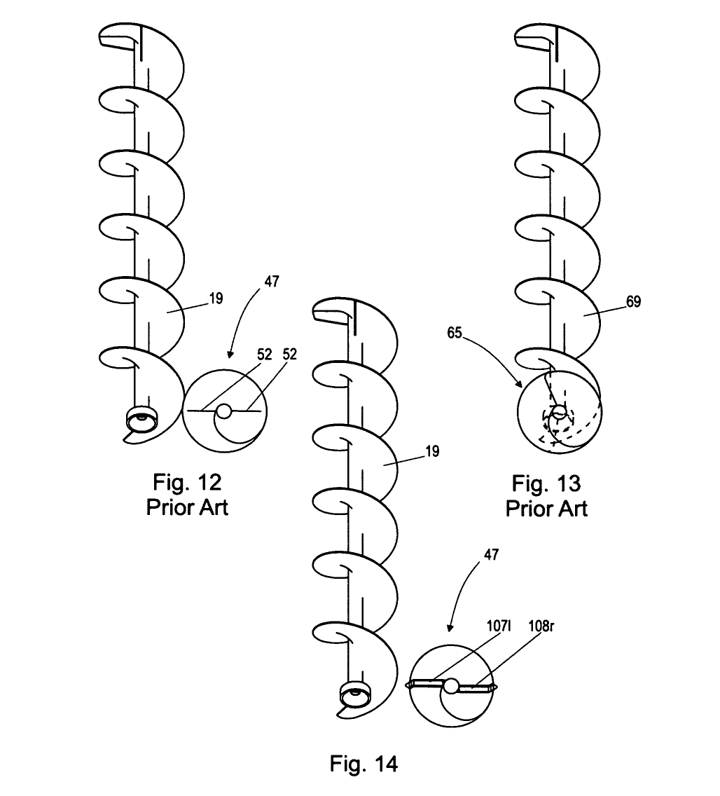

FIG. 8: Shows a perspective view of prior art flat pusher vanes 52 as joined to center shaft 45 and to right sweep auger 46 and left sweep auger 47 by their respective spiral flights. Left-hand spiral flight 48 is attached to right sweep auger 46 and pushes grain inward, while right-hand spiral flight 49 is attached to left sweep auger 47 and pushes grain inward.

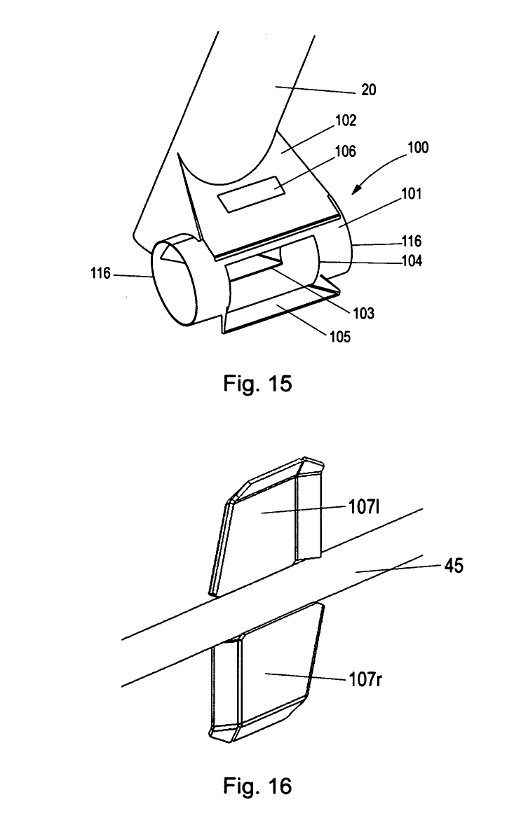

FIG. 9: Shows a perspective view of right sweep auger 46 and left sweep auger 47 as they enter prior art grain chamber 50 that is attached to grain discharge tube 20, through side openings 53. The flat pusher vanes 52 and parts of the sweep augers can be seen through the grain chamber's large front opening 51 as well.

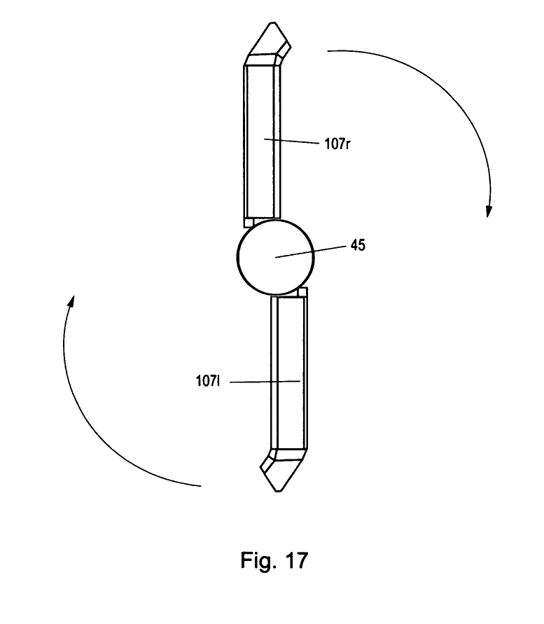

FIG. 10: This is a head-on frontal view of prior art grain chamber 50 that includes right and left sweep augers 46 and 47 respectively, flat pusher vanes 52 and discharge tube 20 at the rear. It shows the large area taken up by front opening 51 on the grain chamber's front face, that allows sizeable end sections of the sweep augers, end sections here being defined as the sections of auger that are enclosed by the grain chamber, to be visible along with the pusher vanes.

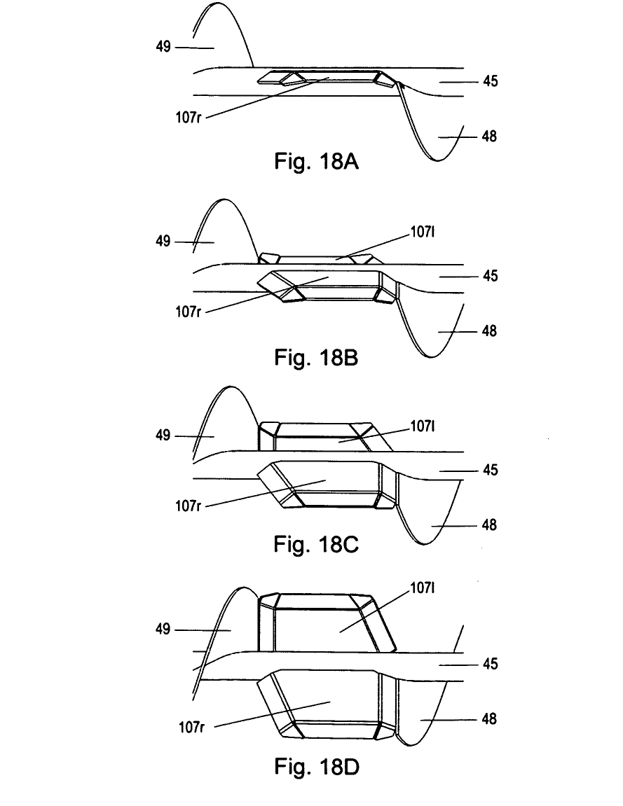

FIG. 11: This head-on frontal view schematic shows a second type of prior art unloader where pusher vanes are eliminated altogether. In this design, a right sweep auger 62 is mounted on a right center shaft 63 fitted with a corresponding left-hand spiral flight 64 to convey grain inward. A left sweep auger 65 is mounted on a left center shaft 66 fitted with a corresponding right-hand spiral flight 67 to convey grain inward. Both sweep augers 62 and 65 go into a grain chamber 68 through side openings in the chamber, not shown. With individual center shafts, the sweep augers are independent of one another and are powered by autonomous drives or transmission means. There is a gap between the inner end sections of the two sweep augers inside the chamber. Discharge auger 69 that runs inside discharge tube 70 and comes into the grain chamber from above, converges on the gap that is left between the end sections of the sweep augers. Thus all three augers coincide inside the chamber on the same vertical plane. A large front opening 71 completes the schematic.

FIG. 12: This diagram represents the relative positions of the sweep augers relative to the discharge auger in prior art unloaders of the first type described, as seen from the left side of the unloader. They are represented by left sweep auger 47 and lower grain discharge auger 20. The horizontal sweep augers are very close to the near vertical discharge auger, if viewed from the left side of the unloader, even to the point of a slight overlapping of their respective spiral flights, reason for which flat pusher vanes 52 have cut-out sections on their forward edges to establish adequate clearance with discharge auger 19. Pusher vanes 52 are sandwiched between right and left sweep augers and mounted on central shaft 45.

FIG. 13: This diagram represents the relative positions of the sweep augers relative to the discharge auger in the second type of prior art unloader depicted in FIG. 11, as viewed from the left side of the unloader. This diagram should be studied in conjunction with FIG. 9, where all the mentioned parts can be viewed from the front. Left sweep auger 65, and in continuation right sweep auger 62, do not share their central shafts, identified with numerals 66 and 63 respectively (FIG. 11), so each auger is driven separately. This permits separation to be established between left and right sweep auger. The low end of lower discharge auger 69 is introduced in this gap, whereupon the three augers converge on the same vertical plane.

### Operation

The previous description of FIGS. 1A, 1B, 1C, 2A and 2B covers all major structural elements that comprise roller-type unloaders in general, but the detailed operational characteristics of mechanical and hydraulic components comprising the driveline is unnecessary because these components, as well as their purpose and function, are well known to the art. Thus the unloader operation account is circumscribed to how the unloader discharges grain from the bag and to relevant components that intervene in a direct manner in the actual unloading process. Numerals that define Figs. will be mentioned as running text or will be enclosed in brackets.

Elements exclusive to this disclosure and its embodiments, as differentiated from elements of roller-type unloaders in general, will be assigned numerals starting with the number 100 and onward in the latter part of the description.

The basic actions that take place at the start of the unloading procedure and during its progression, both in prior art machines and this disclosure, are as follows:

Grain unloader 1 is designed to work by moving rearwardly while attached to tractor 2. In FIG. 5, a curved movement arrow to the left of roller 68 illustrates the direction in which the roller turns as it picks up the used plastic of bag 59 being emptied. The rectilinear movement lines next to unloader 1 and tractor 2 show the rearward direction—as compared with the standard advance direction of a tractor marching forward—in which the free-rolling unloader and tractor tandem are pulled by the action of the turning roller during work. Bag 59 containing grain is a stationary mass that acts as an anchor. Even one or two meters of bag filled with grain is unmovable.

The bag ends are sealed prior to the unloading operation. On commencement of operation, one of the bag's sealed ends is opened. The bag's upper section 59a (FIG. 6) is slit open to allow a breach large enough for the tractor to push the grain unloader rearwardly into it. Only lower discharge tube 20 and the parts comprising the sweep augers and the grain chamber, plus necessarily some sections of the transmission and some support brackets, work inside the bag.

Once sweep augers 46 and 47 (FIGS. 2A and 2B) are inside the bag, first the bag floor or bag's lower section 59b (FIGS. 3 and 4) is attached to bag roller 28 (FIG. 2A) by punching the plastic sheet through holding studs 58 (FIG. 2A) welded along the length of the roller every 40 centimeters or so. Some slack is left in lower bag section 59b to aid the formation of the enlarged bulge or pocket that holds grain at the front end of the bag (FIG. 13). Then the bag's upper section 59a, split in two halves, is passed around lower auger tube 20 and also fastened to bag roller 28 by punching the plastic through the studs. Finally, the bag roller is hydraulically rotated forward about one full turn to secure a firm grip of the plastic sheet around the roller.

With tractor brakes of and gear-case in neutral, PTO 7 (FIG. 1A) is engaged and taken to standard 540 rpm operating speed. The operator descends from the tractor and stands next to hydraulic command center 29 (FIG. 2B), with all levers and speed control knob in neutral mode. A grain cart stands alongside to receive grain from discharge spout 23 (FIG. 2A).

Powered by the tractor's PTO, right and left sweep augers 46 and 47 respectively turn and convey grain from the sides of the bag toward centrally located grain chamber 50 (FIG. 2A). At the hydraulic command center the operator pushes the lever that sets roller 28 turning. As the roller turns, upper bag section 59a and lower bag section 59b tauten and, with the grain bag as anchor, pull at the unloader and attached tractor. Without resistance from brakes or gear-box, the tandem moves in the direction shown by motion arrows in FIG. 5. As the unloader advances, upper bag section 59a is progressively cut open by cutter blade 27 affixed to lower auger tube 20 (FIG. 6). The progressive slit allows the roller to collect the upper section of bag concurrently with the lower section.

The operator stands at the hydraulic controls with line of sight above the bag's top part and checks the mass of grain 60 by peering down the gap opened by blade 27 (FIG. 6). He regulates roller speed by turning a knob of the flow control valve at hydraulic command, and he does this by taking visual cues from the grain level in the bag. The grain level sought is approximately 10 to 15 centimeters beneath the horizontal plane determined by bag roller 28. Should grain level be allowed to rise unchecked, grain can be taken up to the roller together with the plastic. In a few minutes the roller's diameter increases exponentially with the grain inclusions. Large clumps of grain are trapped between the plastic folds and the roller scrapes and jams against other machine parts. This is a different occurrence than takes place when grain accumulates in the front end of the bag (FIG. 4). Grain can be taken up to the roller with the plastic independently of whether grain accumulates at the front end of the bag or not.

Visual feedback enables the operator to set roller rpm so that grain level in the bag remains constant throughout the unloading procedure. This is indicative of balanced grain passage, or equilibrium between the grain volume arriving to grain chamber 50, and the grain volume leaving through lower and upper discharge augers 19 and 21 respectively for discharge into waiting truck or grain cart. Bag roller revolutions per minute are variable and determine the unloader's advance speed. More roller rpm mean faster advance speed, and less rpm mean slower advance speed. Conversely, sweep augers 46 and 47 turn a fixed number of revolutions per minute so they deliver grain to grain chamber 50 at a constant rate. Therefore grain level constancy depends on the right advance speed for the particular variety and condition of the grain that is being unloaded. If grain level in the bag goes up, the unloader's advance is too fast and the augers' or grain chamber's capacity is exceeded. If grain level descends in the bag, the machine is advancing too slowly. Once roller velocity is correctly set, action is automatic and no further action need be taken by the operator except for the occasional visual check.

As the grain floods grain chamber 50 brought in by the sweep augers, it is transferred to the lower discharge auger 19 connected to the chamber through lower discharge tube 20, for final exit from the bag.

The preceding part of the description applies to roller-type unloaders in general, including the present disclosure, except for reference to prior art grain chamber 50. The descriptions in the following paragraphs provide details that pertain to two well known types of prior art unloading machines.

In the first type of prior art unloader, the box shaped grain chamber 50 (FIGS. 7, 9 and 10) generates some frictional force or resistance as it spearheads the unloader's advance through the mass of grain. Grain chamber 50 has four openings: front opening 51 that faces the mass of grain inside the bag, two lateral or side openings 53 that are the access points of right and left sweep augers, and rear opening 61 that communicates with lower discharge tube 20 (FIG. 7).

Running within the grain chamber and extending outward to the sides through lateral openings 53 are right sweep auger 46 and left sweep auger 47 (FIGS. 8, 9 and 10). As seen in FIG. 8, right sweep auger 46 is formed by left-hand spiral flight 48 and central shaft 45. Left sweep auger 47 is formed by right-hand spiral flight 49 and central shaft 45 shared with right sweep auger 46. Both sweep augers convey grain from the sides of the bag toward the center. The end sections of both left and right spiral flights are welded to two identical flat pusher vanes 52 that are 180° in opposition to one another and in turn attached to central shaft 45 by their bases (FIG. 8).

Grain chamber front opening 51 is virtually as large as the front face of the grain chamber. The front opening's approximate size and position overlying pusher vanes 52 and the inner end sections of right and left sweep augers 46 and 47 respectively can be seen in FIG. 10. Grain can escape through the front opening if it cannot be directed out through the discharge auger at the same pace that the sweep augers bring it in. Grain entering directly through front opening 51 as the unloader advances rearwardly can cause churning and turbulence as it interacts with grain brought in by the sweep augers.

The flat pusher vanes 52 (FIGS. 8, 9 and 10) cannot collect extra amounts of grain for delivery to the discharge auger 19 (FIG. 2A) and efficiency diminishes. Grain conveyed via sweep augers that encounters a partial blockage at the grain chamber exacts a toll in several ways. The augers use excessive power to try to force grain into the chamber. Fuel consumption goes up with no advantage gained, wear of the auger material increases. Efficiency is low with regards to tons per hour unloaded. A good portion of grain either backtracks at the chamber entrance or goes in but is expelled though the front opening. That grain is prone to find its way to the front end of the bag where it will cause the problems shown in FIG. 4. As soon as any sign of swelling of the front bag end is noticed, rhythm of work must be drastically reduced by slowing down roller rpm, so schedules are altered.

Grain can have a tendency, depending on type and condition, to skirt around the vane edges as it is pushed by the vanes' flat surface. As the vanes turn 360°, there is some mixing or stirring of grain involved along with the pushing action, which dissipates part of the energy employed to power the vanes. Since the vanes cannot transfer substantial quantities of grain to the discharge auger, the auger may not be carrying a full load of grain outward. Flat pusher vanes create little positive pressure capable of force feeding grain to the discharge auger.

A second type of prior art unloader can be observed in FIG. 11. This development does away with pusher vanes altogether. By having all the augers converge on the grain buildup in the central chamber, the notion that grain transfer between augers should be as direct and uncluttered as possible is carried here to its logical conclusion. FIG. 11 is a front schematic view showing a large box-like central grain chamber 68 receiving inward bound grain from laterally located sweep augers 62 and 65. The front opening 68 is as large as the chamber's front face to allow the maximum inflow of grain into the chamber as the unloader advances within the bag. In this prior art machine, right sweep auger 63 does not share a common central shaft with left sweep auger 65 as occurs in the first type of prior art unloader described. Right and left sweep augers are independent units, each with their own central shaft and individual transmission. The reason for this arrangement is that a shared central shaft would run straight into lower discharge auger 70. Unlike previously depicted prior art unloaders, grain discharge tube 69 that surrounds grain discharge auger 70 is not connected to the rear section of the grain chamber. Instead the opening connecting discharge tube 69 to grain chamber 68 is located on the topmost part of the chamber.

The schematic side views of FIGS. 12 and 13 show the positional layout of sweep augers in relation to discharge augers in prior art unloaders.

FIG. 12 depicts the first type of prior art represented by the grain chamber of FIGS. 7, 9 and 10. In a head-on view from the side, the edge of left sweep auger's right-hand spiral flight 49 is very near or slightly overlaps the edge of the discharge auger's spiral flight. The flat pusher vanes and the sweep augers are in close proximity to the discharge auger. The reason for sweep augers to be very close to the discharge auger is to facilitate the exchange of grain between them. Being close together, the grain chamber containing the sweep augers and the discharge tube containing the discharge auger virtually form a continuous cavity or compartment that is inundated with grain. Consequently, the discharge auger is immersed in the grain agglomeration contained in this cavity or compartment. Yet the auger is not force fed grain to an appreciable degree. There are the grain deficit factors that expel grain through the chamber's front opening: more grain coming into the chamber than can be processed, sweep auger centrifugation, colliding streams of inward bound and outgoing grain, turbulence. The grain exiting through the front opening generates a loss of pressure inside the chamber. The flat pusher vanes cannot fully compensate for this because of the inherent design limitations. They generate scarce positive pressure capable of force feeding grain to the discharge auger to augment its carrying capacity significantly. It should be pointed out that the slow advance speed of the unloader inside the bag does not generate a significant amount of grain pressure through the chamber's front opening to aid in force feeding the discharge auger.

FIG. 13 shows the second type of prior art: the grain chamber of FIG. 11. In a head-on view from the side it is clearly seen that the lower discharge auger converges on the gap between the sweep augers, so that all three augers lie on the same vertical plane. The discharge auger does not depend on any form of forced feeding, since the system does not involve pusher vanes of any kind. No positive pressure is created inside the chamber. In fact, if the chamber were removed entirely, performance would not change appreciably. The arrangement is an offshoot of the tried and true method of immersing an auger in a pile of grain, and keeping the pile continuously replenished so that the auger does not run dry. Thus there is no mechanism in place to augment the discharge auger's conveying capacity through force feeding.

In relation to unloader operation, FIGS. 3 and 4 show sectional side views of grain bags and possible outcomes of the filling procedure. FIG. 3 depicts a well shaped bag. The front bag end shows a normal sized bulge or prominence caused by the weight of the grain it contains. The bag front end maintains adequate clearance from wheel assembly 4. Volume of the bag's front end is stabilized, grain in that sector neither increasing nor diminishing in quantity as the bag is being emptied. There is an equilibrium. This is indicative of good grain flow dynamics.

FIG. 4 shows a bag with an enlarged front end, containing far too much grain and protruding forward to the extent that lower bag section 59b scrapes against wheel assembly 4. Once grain goes past the threshold marked by the line of the sweep augers without being picked up, it has passed into the bag's front section and has propensity to stay there. Unless roller speed is reduced, more grain will accumulate in that spot, raising the probability of bag rupture. Even if roller speed is drastically reduced, grain that has built up at the front end of the bag tends to remain stagnant and it is difficult to detain and reverse the process.

In particular, grain that has a higher moisture level where individual grains cling to each other, has more of a propensity to move to the front end of the bag. The same happens with grain that naturally clings together due to the geometry of the individual grains, as is the case of chickpeas. Grain in this condition is more prone to accumulation at the front end of the bag. During work, the sweep augers can collect and convey this grain inward. However upon reaching the grain chamber, unless effective means facilitate the passage of material from grain chamber to discharge auger, this transfer is slow-moving. The resulting partial blockage restricts access of grain to the grain chamber. If the bag pickup roller rpm are not slowed down, grain circumvents the sweep augers that are already loaded with grain that they cannot discharge due to the bottleneck situation in the grain chamber. This grain migrates to the front end of the bag, causing the problematical buildup depicted in FIG. 4.

### II) Description of First Embodiment

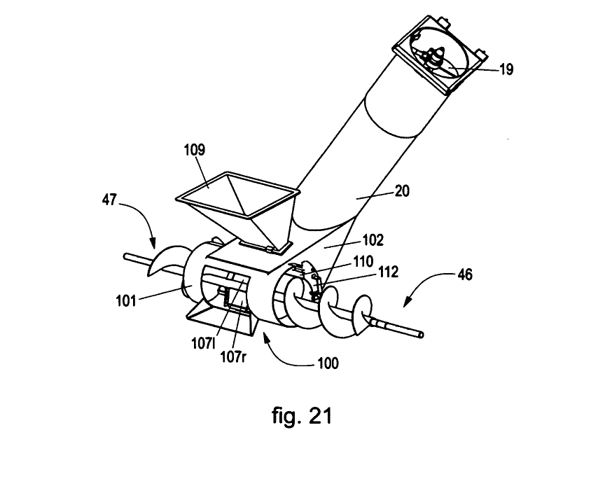

FIG. 14: This diagram represents the relative positions of the sweep augers relative to the discharge auger in all embodiments of the present disclosure, as seen from the left side of the unloader. The numerals shown correspond to the first embodiment. There is an appreciable gap between lower discharge auger 19 and scooped pusher vanes 107r and 107l sandwiched between the sweep augers. Left sweep auger 47 is represented in the diagram.

FIG. 15: This perspective shows a view of the reception and transfer point, or grain chamber 100 as part of the first embodiment. For convenience in describing this and other embodiments, instead of designating it as the single unit which it really is, grain chamber 100 is divided into (I) a cylindrical front section 101, which is the front part in the shape of a cylinder or cylindrical tube, and (II) a rear part or prolongation 102. Since the cylindrical shape is a distinguishing feature of chamber 100, the term cylinder or cylindrical may sometimes be used in this disclosure as either referring to the entire chamber 100 or only to its front section 101 that is the actual cylinder, a distinction that on occasion will be immaterial. This applies as well to further embodiments that will be described. Inside front section 101 will be fitted the means that bring grain into the grain chamber and then push it rearward to the grain discharge auger.

To the rear of the horizontal and transversely extending cylinder that makes up front section 101 there is a grain passageway 103 that permits the passing of grain into rear prolongation 102. Rear prolongation 102 is a duct that connects front section 101 to lower discharge tube 20 that encloses lower discharge auger 19 (not shown) for final conveyance of grain out of the bag. Other parts that comprise grain chamber 100 are a front opening 104 and a tray extension 105 extending below the front opening to guide and facilitate the entrance of grain through the opening and into the chamber.

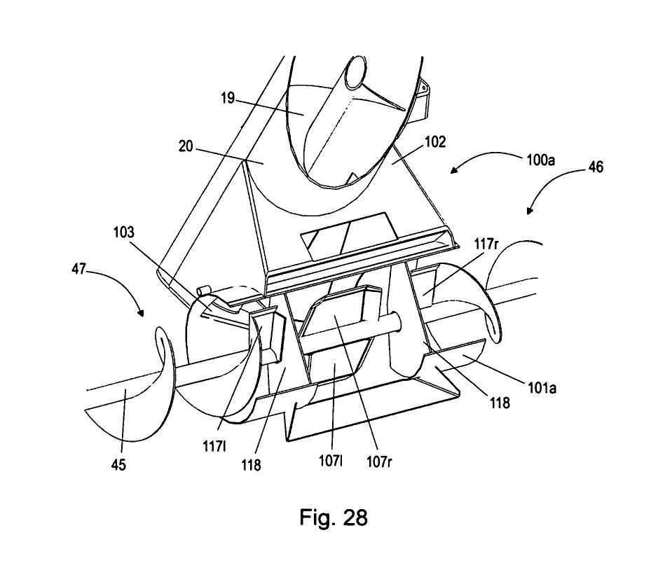

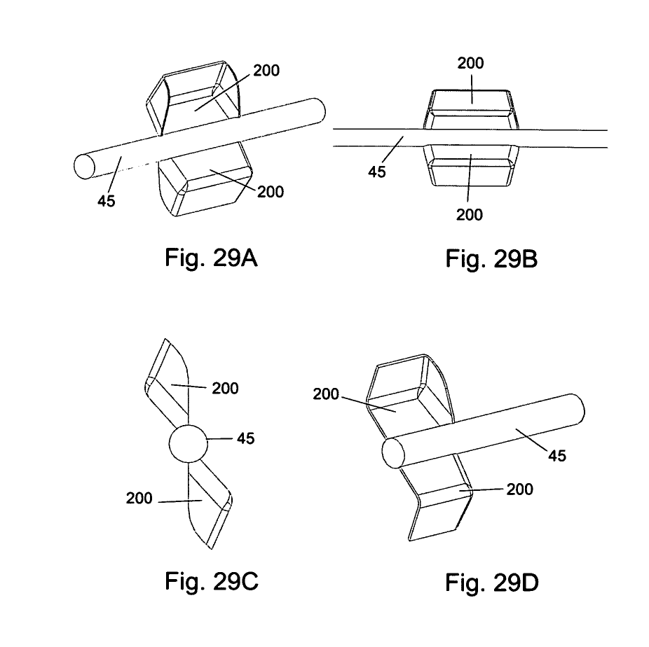

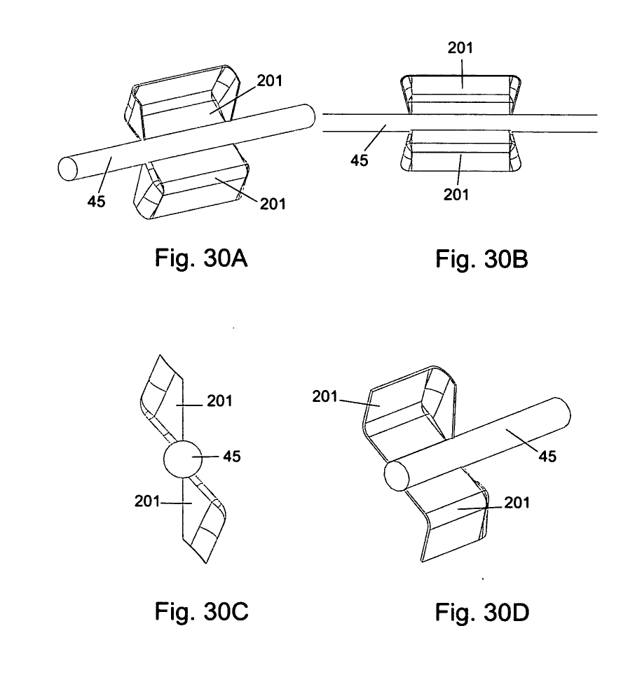

Front section 101 has a length of solid or closed tubular portions or sections extending inward from the cylinder's outer open ends 116 up to where openings are cut out on the cylinder, namely front opening 104 on the anterior face of the cylinder, and grain passageway 103 on the posterior face of the cylinder. The size of the passageway corresponds approximately to the square cross-section of rear prolongation 102 to which it leads, the rear prolongation being a short duct so that the passageway is very near the discharge tube and auger (see FIGS. 23A and 23B). The prolongation's cross-section in turn corresponds approximately to the maximum area of discharge tube 20 that can be cut out so that the rear prolongation can access discharge auger

19. The maximum area that can be cut out of the discharge tube depends in turn on its diameter. On the upper part of rear prolongation 102 there is an open slot serving as a grain entryway or grain inlet 106 for an outer source of grain, specifically for installment of a an auxiliary hopper for the manual loading of grain. Auxiliary hoppers for loading the last grain remaining in the bag are a standard feature of roller-type unloaders.

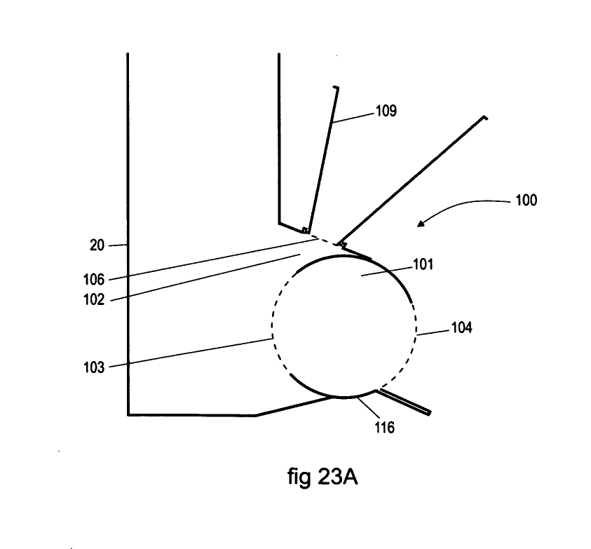

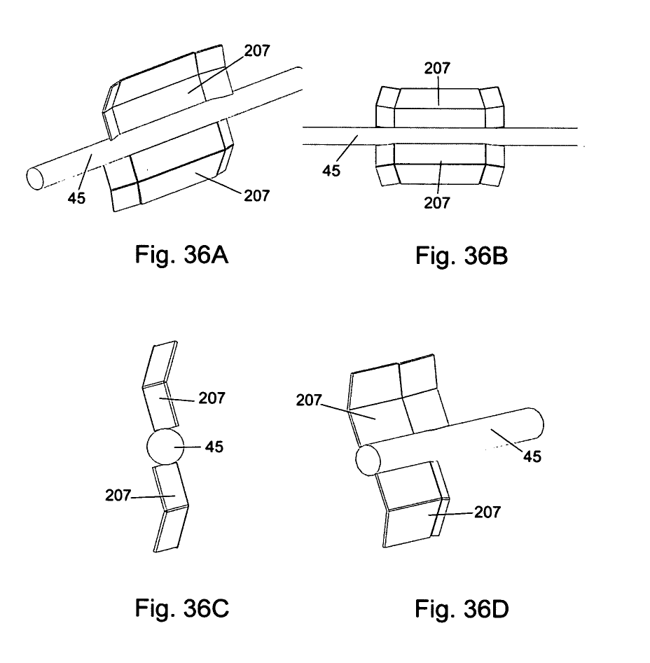

FIG. 16: This is a perspective view of a dual set of curved, concave, or scooped pusher vanes 107r and 107l, a right vane and a left vane respectively, so denominated because right vane 107r will be attached by its side to right sweep auger 46 and left vane 107l will attached by its side to left sweep auger 47 as part of the first embodiment. The scooped pusher vanes are shown here attached to center shaft 45 but still not attached to their respective sweep augers. In this depiction, the vanes are not identical but are bilaterally asymmetric, because the side of each vane that is not welded to its corresponding sweep auger slightly extends laterally in order to provide extra scooping surface. This will be more clearly seen in views provided of the scooped vanes in the series of pictures 18A, 18B, 18C and 18D, where the vanes are shown attached to the sweep augers. Scooped pusher vanes may possess bilateral symmetry and in that case the installed pusher vanes would be identical, without the differentiation of a right and a left vane that are exemplified by vanes 107r and 107l in this embodiment. In the series of FIGS. 29 to 36 will be shown examples of different embodiments of scooped pusher vanes. Some will have lateral symmetry and others will not.

In this case scooped vane 107r in lowermost position in the drawing shows its convex side or face while scooped vane 107l in the topmost position in the drawing shows its concave side or face. In most drawings, unless specified otherwise, the vanes are represented as manufactured in cut and bent sheet metal, but can be manufactured by molding or stamping methods. This along with design variations is shown in drawings 29 to 36.

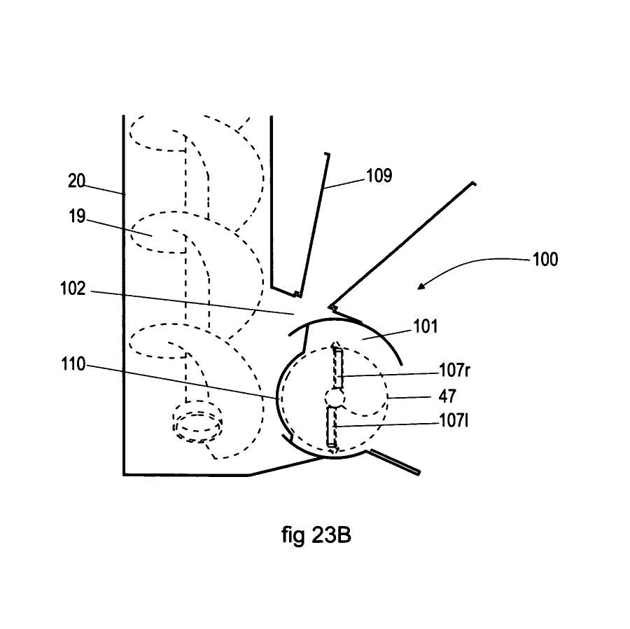

FIG. 17: This view from the right side of the unloader shows scooped vanes 107r and 107l mounted on central shaft 45. Clockwise motion arrows show the rotational direction of the scooped vanes when viewed from the right side of the machine, as they work thrusting grain toward rear prolongation 102 of grain chamber 100. Their upward to downward movement with their concave surfaces to the fore, as shown by the motion arrows, is determined by the standard direction of rotation of the tractor's PTO. This in turn determines the rotational direction of the unloader's mechanical drive and consequently the direction in which sweep augers and pusher vanes turn.

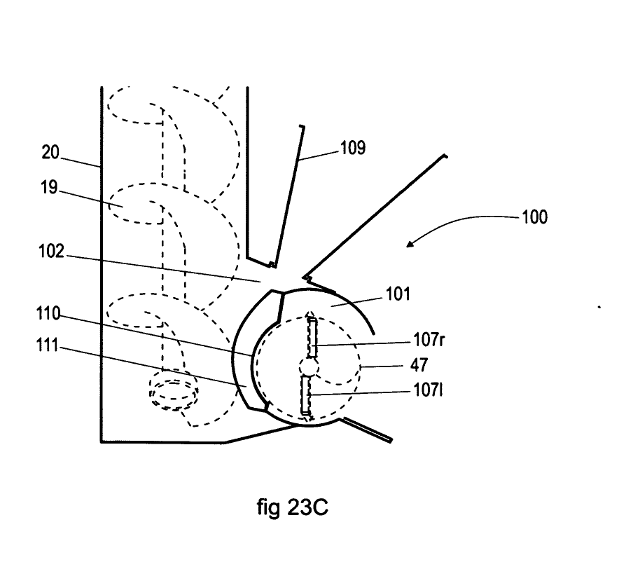

FIGS. 18A, 18B, 18C and 18D: This sequence shows a series of four consecutive views of scooped pusher vanes 107r and 107l where their concavity can be appreciated, attached to central shaft 45 and to right and left sweep augers, as they gyrate.

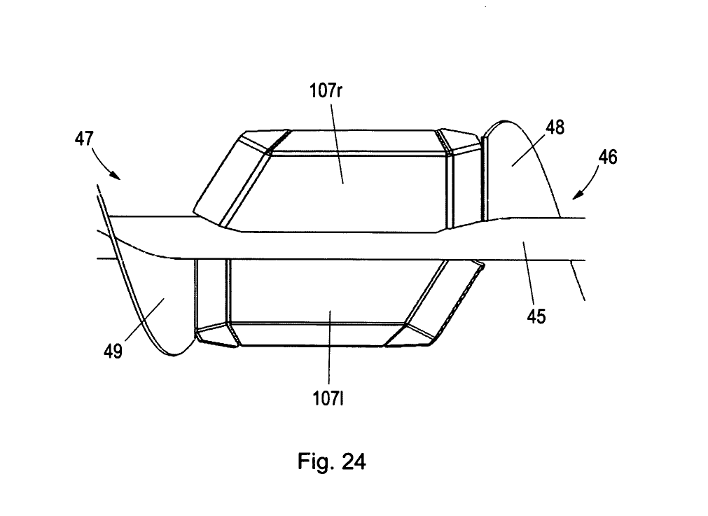

FIG. 19: This perspective view of the first embodiment shows grain chamber 100 fitted with the set of right and left sweep augers 46 and 47 respectively, assembled together with scooped vanes 107r and 107l. On the top face of the chamber's rear prolongation 102 can be seen grain inlet 106. Side openings 116 are the open ends of the chamber's cylindrical front section 101. Joined to the back of the chamber's rear prolongation is lower discharge tube 20.

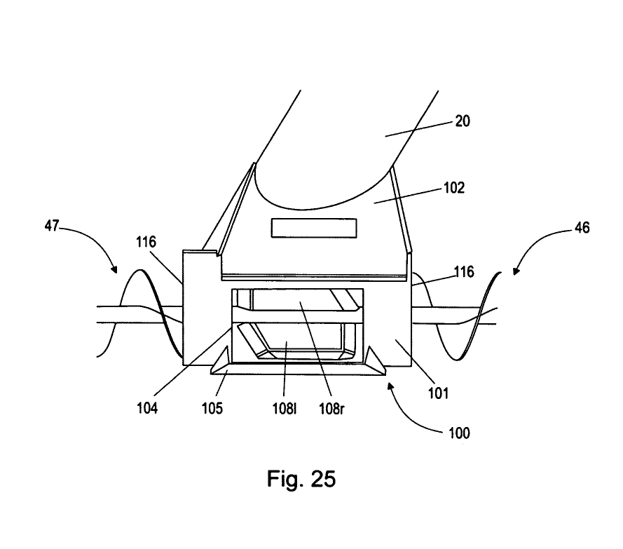

FIG. 20: This frontal head-on view shows a front view of the first embodiment of the present disclosure. It shows right sweep auger 46, left sweep auger 47, grain chamber 100 with front cylindrical section 101, front opening 104, tray extension 105, rear prolongation 102, right scooped vane 107r and left scooped vane 107l. Lower discharge tube 20 is in the background. The inner end sections of right sweep auger 46 and of left sweep auger 47 that are welded to spiral flights 48 and 49 respectively can be seen through front opening 104. Two closed tubular sections can be observed extending inwardly from the front chamber's side openings 116 up to front opening 104.

### Operation

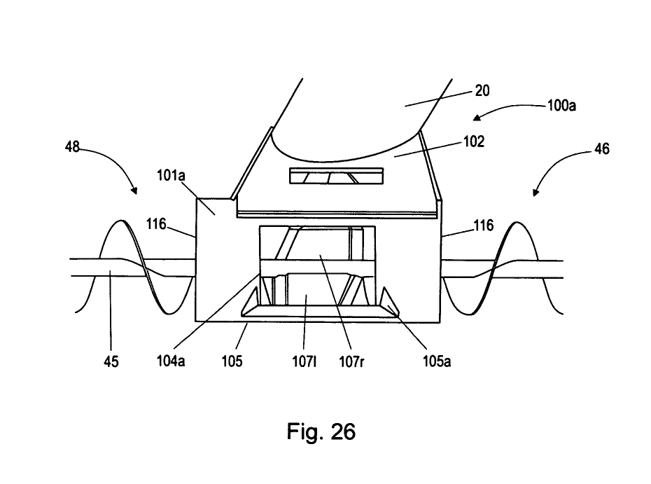

Grain chamber 100 (FIG. 15) presents a round section, tube-shaped or cylindrical front part or forward section 101 with a front opening 104 that allows the entrance of grain. A tray extension 105 is fastened below front opening 104 to help guide grain into the opening. Cylinder shaped front section 101 is transversely attached to rear prolongation 102, which in turn communicates with lower discharge tube 20 and lower discharge auger 19 (FIGS. 19, 20, 21). To the sides of the forward section cylinder are its open ends 116, through which the sweep augers bring grain into the chamber. Rear prolongation 102 has a slot or grain inlet 106 on its upper face to which will be attached an auxiliary hopper 109 (FIG. 21) in the last phase of unloading.

The frontal view of the chamber assembled with right sweep auger 46 and left sweep auger 47 attached to right scooped pusher vane 107r and to left scooped pusher vane 107l cis seen in FIG. 20.

Front section 101, with its rounded contour, creates minimum friction force or resistance as it moves through the mass of grain within the bag. While serving this purpose, the cylinder's open ends provide at the same time an ideal passageway for the sweep augers into the grain chamber, since its round cross-section corresponds with the sweep augers' own round cross-section. FIGS. 19 and 20 show grain chamber 100 fitted with right sweep auger 46 and left sweep auger 47, and scooped pusher vanes 107r and 107l, visible within the chamber.

As grain conducted by sweep augers 46 and 47 enters the closed tubular sections of the chamber's front part 101, it is guided to the scooped pusher vanes. The closed tubular sections are defined as the solid sections of cylindrical tube to either sides of front opening 104. They can also be defined as the solid sections of cylindrical tube adjoining the cylinder's side openings 116 (FIGS. 15 and 20). These closed tubular sections act as grain conduits that completely enclose the grain and guide it smoothly without turbulence or agitation, thus permitting more grain to come into the chamber. As grain conduits they ensure smooth and efficient passage of grain into the chamber.

Thus the advantages that can be ascribed to the cylindrical chamber design over prior art chamber design are: 1) its rounded form and lack of sharp edges conform a stylized design that produces less frictional resistance to advance, thus a reduced need for horsepower, 2) its open ends and cylindrical shape provide an optimum entryway and conduit for the augers and the grain they convey, 3) its closed tubular sections encircle the grain and guide it smoothly, preventing turbulence and resulting in improved sweep auger carrying capacity.

Concave vanes or paddles are construed as a means attached to a driven shaft that collect and convey granular and flowable materials such as grain in a bag.

Concave, cupped, incurvate or scooped pusher vanes can collect and convey large quantities of grain, unlike flat vanes. FIG. 16 shows a perspective view of scooped pusher vanes 107r and 107l mounted to center shaft 45. FIG. 17 shows the vanes as seen head-on from the side, and the numeral 18 sequence shows their aspect as they rotate. These particular vanes are manufactured in cut and bent sheet metal

Concave pusher vanes can be manufactured with different techniques and materials, as will be shown later in this description, but more importantly can be optimized to push forward as much material as necessary to keep the discharge auger fully loaded.

In contrast with flat vanes that can only push grain situated in front of them and cannot hold any, concave vanes or paddles 107r and 107l capture and retain grain in their hollow faces prior to thrusting it to rear section 102 of the grain chamber and on to lower discharge auger 19 further back. Each 360° turn of central shaft 45 fitted with scooped vanes conveys considerably more grain than if the shaft were fitted with flat vanes. The action of conveying more grain means that the grain chamber's rear prolongation 102 is constantly filled with grain. The rotating scooped vanes, acting as paddles, continuously and actively bring forth more grain and push it to the chamber's rear prolongation 102 and on to adjoining lower discharge auger 19. Rear prolongation 102, a short duct communicating with the discharge tube and auger, is constantly packed full with grain.

Since the vanes continuously introduce substantial amounts of new material to the rear of the chamber, grain is force fed to the discharge auger with considerable energy. The discharge auger transports far more grain than it would carry if it were simply immersed in a pile of grain, fed by flat pusher vanes. Accomplishing this objective substantially increases the grain volume per unit of time that can be extracted from the bag, thwarts the possibility of a partial blockage or bottleneck occurring within the grain chamber due to grain chamber or pusher vane design limitations, permits an even flow of grain to be carried to the grain chamber by the sweep augers, ensures that the grain chamber has the capacity to process all the grain that it receives both from the sweep augers and from the grain chamber's front opening, and prevents undue accumulation of grain in the front section of the bag.

Grain does not accumulate at the front of the bag because the positive action of the scooped vanes prevents any partial blockage at the grain chamber due to slow moving passage of grain to the discharge auger. Therefore the sweep augers are not clogged with grain that they cannot transfer to the chamber. The grain is delivered to the chamber and hence to the discharge auger in real time. As the unloader advances, the grain no longer circumvents the sweep augers and thus the undesirable grain accumulation of FIG. 4 does not take place.

This improved grain circulation circuit has an effect on important operational aspects.

Firstly, tractor power requirements diminish. More tons per hour can be unloaded with smaller tractors. Sweep auger action is responsible for a significant percentage of the horsepower employed when unloading grain. In prior art unloaders, normally when working with free flowing dry grain, the sweep augers are not visible because they work submerged in the grain that they shove into the chamber. Modifications of the scooped pusher vanes introduced and described in this embodiment substantially improve grain processing capability. The sweep augers have no need to force-feed grain into grain chamber 100 because grain flow finds little resistance. Contrasting with this, grain is force fed to the discharge auger by the scooped vanes because these impel considerable quantities of grain backward with great energy, forcing grain into the discharge tube. This is the reason why the sweep augers do not need to force-feed grain into the chamber. With no bottleneck condition to contend with because grain circulation does not stall at the discharge point, the sweep augers have far less of a workload. This leads to them collecting and conveying grain more speedily and with less effort.

Secondly, the augers require substantially less rpm to convey the same amount of grain because they find less resistance. The grain is no longer accumulating at the entrance of the chamber's side openings, backtracking because there is no room in the chamber. Sweep augers no longer work fully submerged in the mass of grain because of the speed with which grain is carried away. This causes the mass of grain to cave in around the augers to replace the displaced material, making the spiral flights project above grain level. Auger replacement is an important cost consideration when augers wear down. Wear and erosion of material are dramatically reduced when the augers turn at considerably less revolutions per minute.

Thirdly, mechanical reliability increases because moving the grain requires a reduced amount of power. Less force is applied to transmission components, which results in less mechanical stress and less instances of driveline failure.

### III) Description of Second Embodiment

FIG. 21: This perspective view of the rear part of an unloader shows the main components of the second embodiment: grain chamber 100 with component parts front section 101 and rear prolongation 102, right sweep auger 46, left sweep auger 47, lower discharge tube 20 and lower discharge auger 19 that runs within. An auxiliary hopper 109 is fixed atop rear prolongation 102 over grain inlet 106 (not visible). At the rear of cylindrical front section 101 can be seen a removable end support or bracket 112 against side opening 116, and a small section of a curved partition 110. The curved partition is inserted within front section 101 and impedes grain retrocession when loading manually through auxiliary hopper 109.

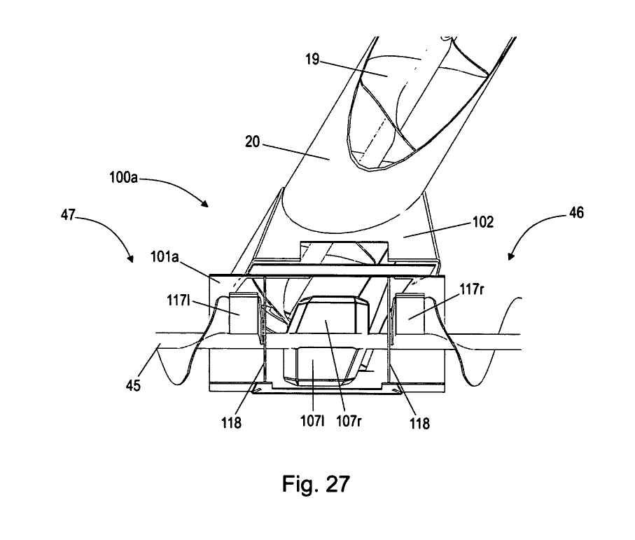

FIG. 22: This perspective view shows curved partition 110 of the second embodiment, a steel plate cover that is laterally inserted at the rear of cylindrical front section 101 to seal grain passageway 103. There is a fixed end bracket 111 attached to one of the partition's ends to help introduce it in place and pull it out. There is a removable end bracket 112 at the other end of the partition that is detached when inserting the partition and is thereafter reattached. Partition 110 is wedged against the inner surface of the cylinder, and end brackets 111 and 112 serve the purpose of keeping it firmly in place. The end brackets lie flush against side openings 116, and are attached to bushings welded to the grain chamber (not shown) by means of pins 113. The end brackets have handles 114 to facilitate handling. Removable end bracket 112 holds down its side of the partition by means of clip fasteners 115.

FIG. 23A: This sectional view of the machine as seen from its left side shows an outline of the grain processing sectors without inclusion of their inner components. Major parts delineated are grain chamber 100, front section 101, rear section 102 and discharge tube 20. Auxiliary hopper 109 for manual loading is fitted atop chamber's rear section 102. The drawing purports to show the points of grain entry and circulation. During the main and automatic stage of the unloading procedure, grain enters the chamber through front opening 104 and side openings 116, both located on front section 101. All grain entering the front section is channeled through grain passageway 103 at its rear. In the final phase of unloading grain from the bag, when grain is manually shoveled in through auxiliary hopper 109, it enters through grain inlet 106. Openings 103, 104 and 106 are depicted in dotted lines for easier identification.

FIG. 23B: This sectional view is similar to the previous outline of FIG. 23A, with the addition of internal components discharge auger 19, scooped vanes 107r and 107l and sweep augers. The latter are represented in this case by left sweep auger 47 that is closest to the viewer. Curved partition 110 is in place wedged against the rear of front section 101.

FIG. 23C: This sectional view is similar to the previous outline of FIG. 23B, with the addition of the end brackets over curved partition 110. The end brackets are represented in this case by fixed end bracket 111 that is closest to the viewer. All Figs. numbered as 23 belong to the second embodiment.

### Operation

The design of the grain chamber in the present disclosure includes a gap between the scooped pusher vanes and the lower discharge auger, as can be seen in the comparative diagram of auger placement of FIG. 14. This arrangement offers the possibility of improving the final stage of the procedure, when the unloader reaches the end of the bag and can advance no more. There is still an appreciable quantity of grain remaining in the bag that must be loaded manually.

Unloaders of the roller type usually have a rectangular opening or open slot on the top facing of their grain chambers, to which a small portable or auxiliary hopper is attached. The end of the bag is slit open and grain is shoveled in by hand and enters the chamber to be directed to the grain discharge auger. This has a drawback: as it turns, the discharge auger churns out grain due to the relatively meager stream of grain falling downward through the slot and hitting with force against the outer edges or spiral flight of the discharge auger. As the grain chamber and the sweep augers are empty of grain, there is no barrier to contain the grain spewed out in this way. A relevant percentage is thrown out of the lateral and front openings of the chamber. This grain is either lost or can be shoveled back in if it falls on the pile of remaining grain, slowing down the manual loading procedure by several minutes.

FIG. 21 is a perspective view of the rear section of the unloader showing auxiliary hopper 71 already installed for manual loading. A small section of curved partition 110 is visible, and so is fixed end bracket 112.

FIG. 22 shows curved partition 110 and its parts. This partition is introduced between the cylindrical front section of the chamber and its rear prolongation to prevent grain seepage and loss when loading grain manually.

FIG. 23A is a cross section outline of the grain chamber and the discharge tube. The inner parts are not shown as the diagram purports to show the chamber's openings, depicted by dotted lines. Grain from the bag comes in through front opening 104 and through side openings 116 (FIG. 15) of front section 101. During standard operation while sweep augers are working, grain passes from the front section to rear prolongation 102 through grain passageway 103 which is roughly the size of front opening 104.

During the manual loading operation, grain inlet 106 permits the entry of grain directly into rear prolongation 102, sidestepping front section 101. The reason for sidestepping the front section is that the sweep augers are at a standstill when manual loading is underway, so the pusher vanes cannot be used to impel the grain. The augers are disengaged because the machine can unload no more grain when it gets to the end of the bag. They are also disengaged for reason of operator and bystander safety, as people move near the augers when loading manually. Grain introduced manually must enter through a secondary opening. In prior art machines, this secondary opening is located above the grain chamber as well, but the grain chamber is a single chamber compartment and there is no clearance between sweep augers and discharge auger (FIG. 12). Thus a barrier cannot be interposed between both sets of augers and grain spewing from the discharge auger during manual loading is lost through the prior art chamber's front and side openings.

FIG. 23B shows the same cross section profile with the inclusion of lower discharge auger 19, left sweep auger 47 and scooped pusher vanes 107r and 107l. Curved partition 110 is shown by a solid black line, installed at the rear of front section 101.

FIG. 23C shows the solid outline of removable end bracket 112 placed over partition 110, at the far end of forward section 101. The partition is fitted in the following way: detachable end bracket 112 is removed and curved partition 110 is introduced inside the back part of cylindrical front section 101a, where it is wedged against grain passageway 103. The partition blocks the passageway and stops grain churned out by lower discharge auger 19 from flowing to the forward section to be lost.

Once partition is inserted in place, the fixed end bracket is attached by means of pins 103 to grain chamber 100. The other end of partition 110 is then affixed to detachable end bracket 112 by means of clip fasteners 115 (FIG. 22). Bracket 112 in turn is attached to its side of the grain chamber with pins 103.

As seen in FIG. 22, fixed end bracket 111 has a handle 114 for pushing the partition into the grain chamber and for pulling it out, as has detachable end bracket 112. The end brackets serve the function of holding curved partition 110 flush against grain transfer opening 103 to prevent grain from seeping through a loose partition. Many support bracket designs or other kinds of arrangements would serve the same purpose.

### IV) Description of Third Embodiment

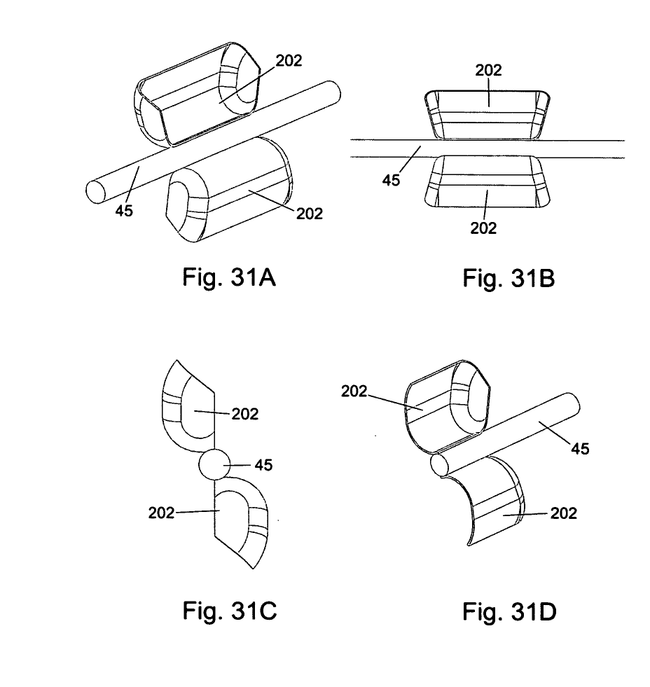

FIG. 24: This perspective view shows a right scooped pusher vane 108r and a left scooped pusher vane 108l. They differ from their counterparts 107r and 107l in being wider and so offering additional scooping surface. They are part of the second embodiment described in the operating section of the description. The vanes are attached by the base to central shaft 45. Here they are seen from the rear side of the unloader, or front side of the grain chamber. Right scooped vane 108r is in the lowermost position showing its concave side to the viewer—the point of attachment of the vane's base to the central shaft is behind the shaft, as indicated by the dotted lines—and left vane 108l is in topmost position showing its convex face to the viewer. As in the case of vanes 107r and 107l, vanes 108r and 108l are not laterally symmetric. Scooped vane 108r is welded by its right side to left-hand spiral flight 48 that belongs to right sweep auger 46. Its left side can be seen extending toward the left to cover extra surface, descending to the shaft in a sharper angle than the right side. Scooped vane 108b is welded by its left side to right-hand spiral flight 49 belonging to left sweep auger 47 and its asymmetric outline can also be clearly seen. Both vanes are attached by their bases to sweep auger central shaft 45.

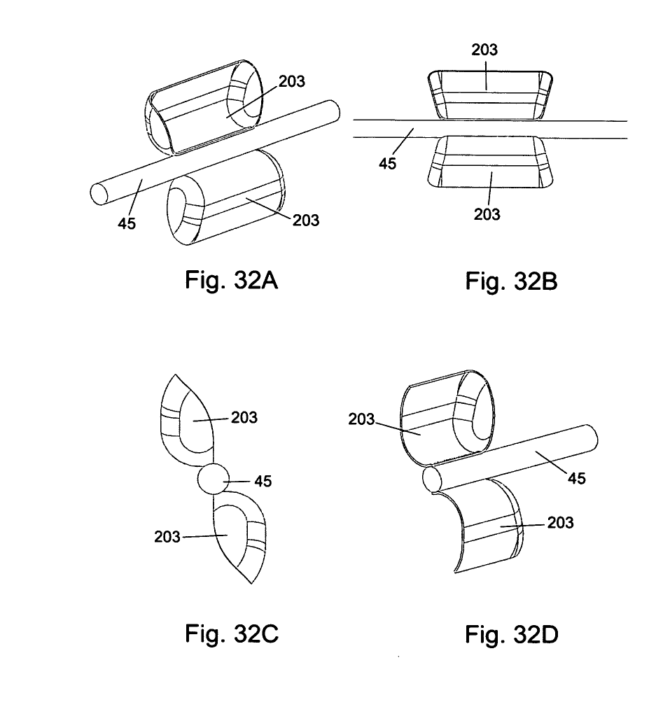

FIG. 25: This drawing shows a front view of the third embodiment of the present disclosure. It shows right sweep auger 46, left sweep auger 47, grain chamber 100 with front cylindrical section 101, front opening 104, tray extension 105, right scooped pusher vane 108r and left scooped pusher vane 108l. Lower discharge auger 20 is in the background. In this embodiment, the scooped vanes 108r and 108l are considerably wider, as measured horizontally along the cylinder's longitudinal axis, than their counterparts 107r and 107l shown in FIGS. 24 and 25. They take up the full width of front opening 104a of grain chamber 100a. Front opening 104a overlies scooped vanes 108r and 108l but does not overlie the inner end sections of right sweep auger 46 or left auger 47. The inner end sections of the sweep augers are not visible as they are covered and shielded by the solid tubular sections that extend inwardly from side openings 116.

### Operation

In FIG. 20 depicting the first embodiment, it is seen that front opening 104 is superimposed on segments of the inner end sections of right sweep auger 46 and left sweep auger 47. The front opening is designed to allow the entrance of grain into the chamber as the machine advances within the bag. In the first embodiment, this grain is picked up by scooped vanes 107r and 107l and impelled to the unloader's discharge auger behind the grain chamber. However, the innermost end sections of sweep augers 46 and 47 in FIG. 15—an end section defined as the auger section that works inside the grain chamber—still overlap partly with front opening 104.

Part of the end sections of the sweep augers are enclosed by the front cylinder's solid tubular sections. Nevertheless, the uncovered or exposed end sections of the sweep augers that bring grain in can still be focal points of interference with grain coming in through front opening 104. It is analogous to the problem encountered in prior art grain chambers. See chamber 50 with its front opening 51 exposing sections of sweep auger spiral flight in FIGS. 9 and 10. The first embodiment compensates this shortcoming with the vigorous action of the scooped pusher vanes that effectively delivers large quantities of grain to the discharge auger, but this aspect of design can be improved.

FIG. 24 shows scooped pusher vanes 108r and 108l also mounted to center shaft 45 and by one of their sides to the spiral flights of the sweep augers. These vanes are wider than their counterparts 107r and 107l but have the same fundamental design.

As can be seen in FIG. 25, front opening 104 covers the total surface of the vanes. No section of sweep auger is left uncovered within the chamber as the front opening completely overlies scooped vanes 108r and 108l. In this way the closed tubular sections adjacent to front opening 104 cover the grain brought in by the sweep augers until it is taken by the scooped vanes and thrust backward by them to the discharge auger. This permits a smooth flow of grain to arrive to the scooped vanes instead of being disrupted or displaced by grain coming in through the front opening or by centrifugal forces acting upon uncovered auger sections.

Many variations are possible when using concave pusher vanes to actively drive grain for faster circulation and discharge of material from a grain bag. In this embodiment as depicted in FIG. 25, scooped pusher vanes 108r and 108l coincide with front opening 104 and continue to pick up grain that comes in through that opening. However a given pair of scooped vanes can fail to process all the grain brought in by the sweep augers plus the grain coming in through the grain chamber's front opening.

Design variations of scooped pusher vanes offer ways of increasing processing capability. FIGS. 29 to 36 show variations of scooped pusher vanes. Some are stamped and some are molded. Some can convey more material than others and are better adapted to some types of grain. They range from high volume designs to extremely simple sheet metal models with only a few bends to configure a scooped shape that will hold grain.

Besides larger sizes, scooped pusher vanes can incorporate other design features for additional collecting and conveying capability. A deeper incurvation or concavity of the vane will result in added carrying capacity. A larger scooped vane surface can be combined with a deeper concavity if more carrying capacity is needed. The scooped vanes should be designed to pick up and send enough grain to rear prolongation 102 as necessary to keep it full at all times. The limit to how much grain the scooped vanes should force into rear section 102 of grain chambers 100 presented here, should be around the upper range of the discharge auger's maximum output capability.

Other arrangements or arrays different from the two opposed scooped vanes 180° apart described until now are possible. For example four scooped pusher vanes can be mounted on central shaft 45 set 90° apart from each other, the two odd scooped vanes added not necessitating attachment to the sweep auger spiral flights. The use of scooped vanes would not be limited either to the mechanical driven sweep augers described here, or even to grain chambers generally designed along the lines of grain chamber 50 or grain chamber 100.

New experimental designs have incorporated individual central shafts for right sweep auger and left sweep auger that are independent of one another, in the manner shown in FIG. 11, but with discharge auger placed behind sweep augers in the usual placement found in the unloaders reviewed here. This approach explores the alternative of powering each sweep auger with less bulky individual drives, or outright replacement of the mechanical drive or drives with hydraulic motors mounted on the outer extremities of both central shafts. In such arrangements, notwithstanding what parameters are used to design the central grain reception point or the grain chamber, scooped pusher vanes can be utilized with the advantages put forth in this disclosure. As an example, scooped pusher vanes could be mounted on the inner end of each sweep auger's central shaft of an unloader fitted with individually driven right and left sweep augers.

### V) Description of Fourth Embodiment

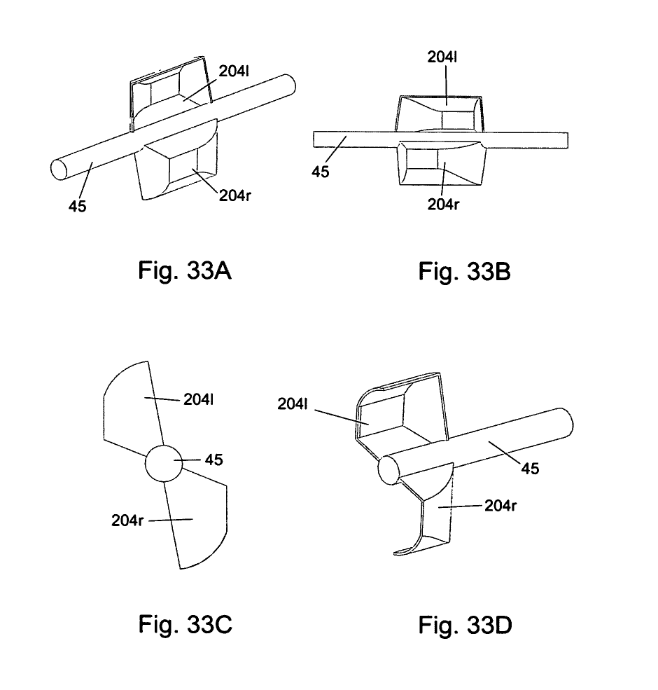

FIG. 26: This a frontal view of a modified version of grain chamber 100. It consists of a grain chamber 100a with a front section 101a. This front section has a front opening 104a that is narrower than equivalent front opening 104 of the other embodiments of this disclosure. Below the opening is an extension tray 105a corresponding to opening 104a. Grain chamber rear prolongation 102 is the same of other embodiments. Right sweep auger 46 and left sweep auger 47 enter the cylindrical front section through side openings 116. Attached to center shaft 45 and visible through the front opening are scooped pusher vanes 107r and 107l. The vanes are not joined to the spiral flights of sweep augers 46 and 47 respectively as in previous embodiments; the vanes are only attached to central shaft 45 by their bases.

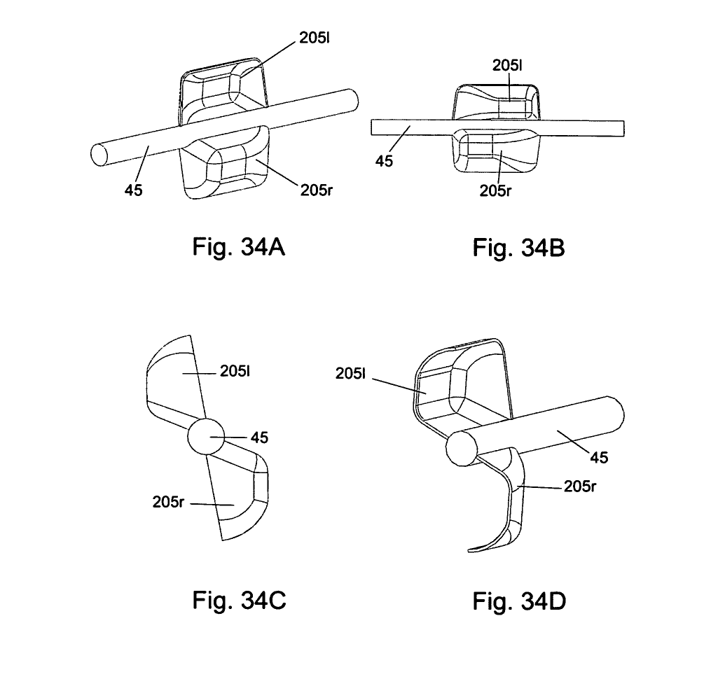

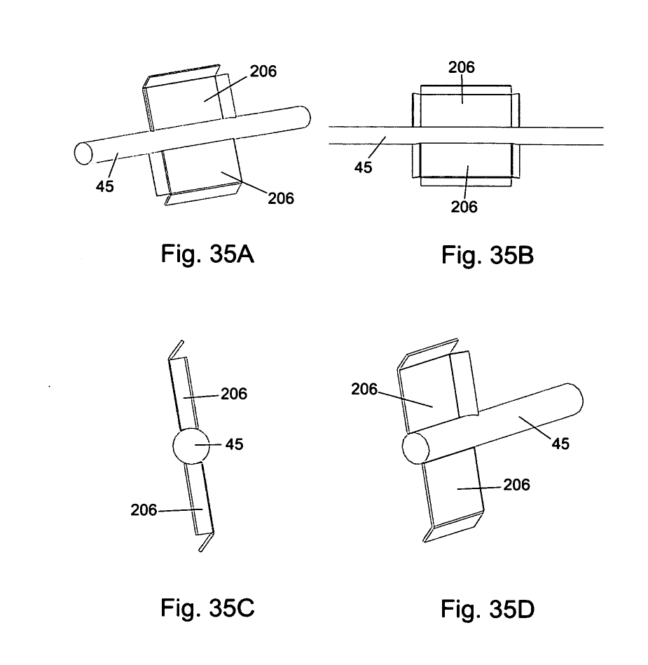

FIGS. 27 and 28: These are partial sectional perspective views of the chamber where the frontal face has been removed to show the modifications within. Two dividers or flat partitions 118 are attached or welded inside cylindrical front section 101a. The partitions intersect the longitudinal axis of the cylinder at a right angle. The vertical attachment point of the partitions to the inner frontal face of forward section 101a runs along the right and left sides of front opening 104a and this determines three sectors, raceways or conduits within the cylinder. The grain chamber has a numeral 100a assigned and a forward section 101a. Central shaft 45 drives scooped vanes 107r, 107l, 117r and 117l and runs through perforations in partitions 118. Besides being attached to the shaft, right and left scooped vanes 117r and 117l are attached by their sides to right sweep auger 46 and to left sweep auger 47 respectively. Centrally located vanes 107r and 107l are attached by their bases to central shaft 45 but partitions 118 cut them off from vanes 117r and 117l and sweep augers 46 and 47.

### Operation

The third embodiment as represented by FIG. 25 uses wide scooped pusher vanes 108r and 108l, with more capacity than vanes 107r and 107l to collect and convey grain. These wide vanes cover the entirety of the chamber's front opening and so leave no portion of the end sections of the sweeper vanes uncovered within the chamber. This eliminates most of the swirling caused by grain streams colliding within the chamber. The surface area and the concavity of these wide vanes allow them to gather and thrust backward considerable quantities of grain with each rotation. Despite this augmented capacity to convey grain, there is still intermixing and consequently some swirling when grain transported by the sweep augers converges on the vane surfaces with grain coming in through the front opening. The considerable capaciousness of the vanes largely overcomes the deficit in throughput that could result as a consequence of this, but the combination of scooped pusher vanes with the grain chamber design presented in the embodiments can be optimized further.

FIG. 26 is a frontal view of a modified version of grain chamber 100. It comprises a grain chamber 100a with a front section 101a. This front section's front opening 104a is narrower than counterpart opening 104 of the other embodiments. Scooped pusher vanes 107r and 107l are not connected to sweep augers 46 and 47 respectively as in previous embodiments. As the vanes turn attached to central shaft 45, they scoop up grain coming in through the chamber's front opening that is immersed in the mass of grain.

FIGS. 27 and 28 are sectional perspectives of the chamber with frontal surfaces removed to show how it is modified. Dual partitions or dividing panels 118 create three separate sectors or compartments within forward section 101a. From right to left, the first sector spans the closed tubular portion that goes from the cylinder's right side opening 116 to the right side of front opening 104a. The second sector spans the width of front opening 104a. The third sector spans the closed tubular portion that goes from the left side of front opening 104a to the cylinder's left side opening 116 (FIG. 26). The partitions cover the full cross-sectional area of the cylinder from front to rear, up to where grain passageway 103 separates the front section from rear prolongation 102. The two dividers or partitions 118 are blind plates except for an orifice in each that is large enough for central shaft 45 to pass through, so there is no communication between the three sectors delimitated in the forward section.

Scooped vanes are mounted on central shaft 45. One, or two, or a plurality of them are fitted on the central shaft within each of the cylinder's three sectors. In FIGS. 27 and 28 a single scooped vane 117r in the right side sector impels grain brought in by right sweep auger 46. Similarly, a single scooped vane 117l in the left side sector impels grain brought in by left sweep auger 47. Right and left scooped vanes 117r and 117l collect and convey grain that comes in through front opening 104a as the unloader advances within the mass of grain in the bag.

The three streams of grain are channeled to the chamber's rear prolongation and on to the discharge auger. In this embodiment, rear prolongation 102 is not modified. In order to optimize flow, rear prolongation 102 can be widened. The width where it joins forward section 101a should be such as to encompass the total span of the vanes mounted on central shaft 45. In other words it should be as wide, or almost as wide, as the length of cylindrical forward section 101a. Grain passageway 103 can be widened accordingly so that grain impelled by outwardly situated vanes 117r and 117l has a more direct, undeviating access to rear prolongation 102. The wider rear prolongation should then taper inward to connect to lower discharge tube 20, and thus provide a gently curving raceway for grain thrust backward by vanes 117r and 117l to reach discharge auger 19. Grain thrust by inwardly situated vanes 117r and 117l is conducted to the center of rear prolongation 102 and on to the discharge auger.

The fourth embodiment provides three separate conduits for grain inward bound to the grain chamber. This grain comes from the right sweep auger, from the left sweep auger, and from the chamber's front opening.

This design precludes the intermixing of grain, and thus eliminates agitation and turbulence that is detrimental to throughput efficiency. The augers are not overtaxed because there is no resistance from accumulation or packing of grain at the chamber's side openings. There is no disruption of the continuous load of grain brought in by the sweep augers, because this inflow of grain does not have any contact with grain coming in through the front opening. Grain input is smooth along the entire circuit, resulting in better throughput figures.

Thus the processing capability of the grain chamber can be adequately matched, in this as in previous embodiments, to the conveying capacity of the discharge auger for an optimized rate of grain extraction from bags.

### Operation of Other Embodiments

Other embodiments or variations of these embodiments can be conceived that combine the features of the grain chamber and the scooped vanes to greater advantage. For example, a deeply scooped vane will convey more grain and permit the unloading of more tons per hour than other, shallower vanes, as long as the grain is dry and flows freely. Grain that is moister and tends to stick together would benefit with vanes that are shallower but have a larger surface. Vanes can be combined and used as single units, can be configured in different arrangements side by side, or several can be coaxially mounted to push more grain. Two units separated by 180° have proven to be one of the most versatile designs to date.

The basic cylindrical shape of the grain chamber is also a versatile design, as it can be easily lengthened to adapt to wider pusher vanes, for instance. One same cylinder diameter can also fit more than one sweep auger diameter. This is because grain flows easily within the closed tubular portions of the cylinder and there is no need to force-feed grain into the chamber, which would require a tight fit between augers and tube. Therefore clearance is not critical. That is the reason for the wide clearance between the sweep augers and the cylinder's inner lining that can be observed in some of the drawings (FIGS. 19, 23B, 23C). The sweep augers are not centered within the cylinder cavity but are designed to scoop grain

### VI) Description of Curved Vanes

FIGS. 29 to 36: These Figs. show a wide range of concave, incurvated, spooned or scooped paddles or vanes that can be mounted to the central shaft that drives the sweep augers. All are shown mounted to central shaft 45. They are assigned the numerals 200 to 207 and 4 different views are shown: A) a perspective view, B) a frontal head-on view showing the full concave and convex faces of the vanes mounted 180° apart, C) a view of the mounted vanes seen head-on from the side, and D) a transverse sectional view.

Most of the vanes shown have bilateral symmetry—FIGS. 29, 30, 31, 32, 35, 36—, while two are asymmetrical—FIGS. 33, 34—and the vanes are denominated as left (l) or right (r) in accordance with the auger they are attached to. Most of the vanes are molded or stamped—FIGS. 29, 30, 31, 32, 33, 34—, while two are very simple designs in sheet metal—FIGS. 35, 36—, one of them with only 3 bends, showing a minimalist version of what constitutes a scooped vane capable of conveying extra quantities of grain in a roller-type grain bag unloader.

### CONCLUSION, RAMIFICATIONS AND SCOPE

The reader will appreciate that the object of the disclosure is the improvement of a grain bag unloading machine's processing capacity by implementing a more efficient grain flow path than is provided by the state of the art. This is achieved through interaction between the grain stored in the bag and the means for extracting it that are the subject of the present embodiments.

These are some of the benefits embodied in the present disclosure as applied to grain bag unloading machines and how they discharge grain from bags:
There is no intermixing, and no whipping and tossing of grain.
Since the scooped pusher vanes can convey as much grain as necessary, there is no bottleneck or partial blockage at the chamber. Consequently there is no positive pressure inside the chamber caused by an excess of grain that cannot be discharged.
The augers are not burdened because there is no resistance derived from accumulation or packing of grain at the chamber's side openings. Such grain would be liable to moving to the problematic front end of the bag.
There is no centrifugal force from uncovered augers inside the chamber.
There is no disruption of the continuous load of grain brought in by the sweep augers.
The grain entering the chamber through the front opening must not contend with an opposing outflow of ousted grain. Grain is ejected when it cannot be discharged out of the bag at a fast enough pace by the normal means. This grain can then find its way to the front end of the bag.
The sweep augers can collect and convey all the grain that they come in contact with as they advance, so grain does not circumvent them to accumulate at the end of the bag.
All grain funneled in manually at the end of the operation is conserved, none is lost.
The end result is better overall efficiency of the bag unloader, resulting in lesser power requirements, improved throughput measured in tons per hour discharged, and diminished wear and tear of machine components.

Although the description above contains many specificities, these should not be construed as limiting the scope of the embodiments but as providing illustration of the possibilities, since the embodiments can sustain changes and rearrangements without departing from the scope of the disclosure as determined by the appended claims.

I claim:

1) A grain bag unloading machine of the so denominated roller type unloader, where the unloader moves rearwardly with respect to the grain bag, attached to a tractor for power or having other means to provide power to all movable parts of said roller type unloader, including means mounted on said roller type unloader itself, said roller type unloader comprising:
a. a wheeled frame,
b. a transversely extended support frame member mounted on said wheeled frame,
c. a bag pickup roller rotatably mounted on said transversely extended support frame member, extending transversely for attachment of a grain bag, for the purpose of collecting the plastic film composing said grain bag as the bag empties,
d. a power and transmission means connecting to said bag pickup roller for powering same,
e. a sweep auger or set of sweep augers powered by the provided power and transmission means, transversely positioned to right and left of center, conventionally denominated as right sweep auger and left sweep auger, for entry in said grain bag for the purpose of collecting and conveying grain along the bag's lateral axis from outward to inward direction, while advancing along the longitudinal axis of said grain bag,
f. A reception and transfer point for grain, said reception and transfer point receiving grain from said right sweep auger and said left sweep auger,
g. an arrangement of at least one concave or concave pusher vane sandwiched between said right sweep auger and said left sweep auger, situated inside said reception and transfer point, whereby said concave pusher vane or vanes propel the grain,
h. a grain discharge auger powered by the provided power and transmission means, enclosed in a grain discharge tube and receiving the grain impelled by said concave pusher vanes for final discharge to an outside container.

2) A grain bag unloading machine as defined in claim 1, further comprising a plurality of concave pusher vanes arranged within said reception and transfer point, whereby said plurality of concave pusher vanes are mounted laterally one with respect to another, or mounted coaxially one with respect to another, or mounted in a combination of both mountings.

3) A grain bag unloading machine as defined in claim 1 wherein said reception and transfer point for grain further comprises a front opening for the direct entry of grain as a result of the unloader's advance through the grain mass in said bag, said front opening overlying said concave pusher vanes.

4) A grain bag unloading machine as defined in claim 1, further comprising at least one partition within said reception and transfer point for dividing the inward bound streams of grain brought by said right sweep auger and said left sweep auger, whereby the streams of grain do not mix upon entering said reception and transfer point.

5) A grain bag unloading machine as defined in claim 3, further comprising at least two partitions within said reception and transfer point for dividing the inward bound streams of grain brought by said right sweep auger and by said left sweep auger, and further brought in through said front opening, whereby the incoming streams of grain do not mix upon entering said reception and transfer point.

6) A grain bag unloading machine as defined in claim 3 wherein said front opening has a horizontally measured width equal to the horizontal width of said concave pusher vanes, whereby said front opening overlies only said concave pusher vanes and does not overlie any section of spiral flight belonging to the right or left sweep augers adjacent to said concave pusher vanes.

7) A grain bag unloading machine as defined in claim 1, wherein the forward section of said reception and transfer point comprises a cylindrical tube with open ends facing sideways for admission of said right sweep auger and said left sweep auger, said forward section further comprising an opening or grain passageway at its rear whereby grain passes backward.

8) A grain bag unloading machine as defined in claim 7, further comprising a rear prolongation of said reception and transfer point, said rear prolongation connected to said forward section through said grain passageway.

9) A grain bag unloading machine as defined in claim 8, wherein said rear prolongation of said reception and transfer point is joined backwardly to said grain discharge tube, providing enough clearance for said concave pusher vanes to gyrate without coming in contact with said grain discharge auger, whereby said concave pusher vanes propel grain onto said grain discharge auger.

10) A grain bag unloading machine as defined in claim 9, wherein said rear prolongation of said reception and transfer point further comprises an opening whereby said opening functioning as a grain inlet for grain coming into said rear prolongation from an outer source other than said forward section of said reception and transfer point.

11) A grain bag unloading machine as defined in claim 10, further comprising a separating means interposed between said forward section and said rear prolongation of said reception and transfer point, thereby blocking said grain passageway to prevent grain loss from grain retrocession into said forward section through said grain passageway, whereby the totality of grain entering said rear prolongation through said grain inlet from said outer source, reaches said grain discharge auger enclosed by said grain discharge tube connected to said rear prolongation for final exit from the bag.

12) A grain bag unloading machine as defined in claim 7, wherein said cylindrical tube as part of said front section of said reception and transfer point, further comprises a front opening for the direct entry of grain as a result of the unloader's advance through the grain mass in said bag, said front opening overlying said concave pusher vanes.

13) A grain bag unloading machine as defined in claim 12, wherein said front opening has a horizontally measured width equal to the horizontal width of said concave pusher vanes, whereby said front opening overlies only said concave pusher vanes and does not overlie any section of spiral flight belonging to the right or left sweep augers adjacent to said concave pusher vanes.

14) A grain bag unloading machine as defined in claim 7, further comprising at least one partition within said reception and transfer point for dividing the inward bound streams of grain brought by said right sweep auger and said left sweep auger, whereby the streams of grain do not mix upon entering said reception and transfer point.

15) A grain bag unloading machine as defined in claim 7, further comprising a plurality of concave pusher vanes arranged within said reception and transfer point, whereby said plurality of concave pusher vanes are mounted laterally one with respect to another, or mounted coaxially one with respect to another, or mounted in a combination of both mountings.

16) A grain bag unloading machine as defined in claim 12, further comprising at least two partitions within said reception and transfer point for dividing the inward bound streams of grain brought by said right sweep auger and by said left sweep auger, and further brought in through said front opening, whereby the incoming streams of grain do not mix upon entering said reception and transfer point.
